(19) United States
(12) Patent Application Publication
(10) Pub. No.: US 2024/0351922 A1
(43) Pub. Date: Oct. 24, 2024

(54) MEMBRANE BIOREACTOR, METHOD OF OPERATING A MEMBRANE BIOREACTOR, AND USE OF A MEMBRANE BIOREACTOR

(71) Applicant: Robert Martinus VAN OPDORP, Amsterdam (NL)

(72) Inventor: Robert Martinus VAN OPDORP, Amsterdam (NL)

(21) Appl. No.: 18/710,189

(22) PCT Filed: Nov. 15, 2022
(86) PCT No.: PCT/NL2022/050655

§ 371 Date: May 15, 2024

(30) Foreign Application Priority Data
Nov. 15, 2021 (EP) 21000325.7

(51) Int. Cl. C02F 3/12; C02F 3/22; C02F 3/30

(52) U.S. Cl. CPC C02F 3/1247; C02F 3/1273; C02F 3/223; C02F 3/301; C02F 2203/008; C02F 2209/005; C02F 2209/40; C02F 2303/16

(57) ABSTRACT

Membrane bioreactor (2) for treating of sewage that includes a first and second bioreaction vessel (4, 6). The first bioreaction vessel (4) includes a first vessel wall (14) for enclosing an internal first vessel space. The second bioreaction vessel (6) includes a second vessel wall (26) for enclosing an internal second vessel space. The first vessel wall (14) includes a convex first peripheral vessel wall part and a first inner vessel wall part (22). The second vessel wall (26) includes a convex second peripheral vessel wall part and a second inner vessel wall part (30). The first vessel wall (14) and the second vessel wall (26) are mechanically connected to each other by means of a vessel connection structure (90). The vessel connection structure (90) positions the first and second peripheral vessel wall parts relative to each other during the treating of sewage.

### FIELD

The invention relates to a membrane bioreactor that is arranged for treating of sewage. The invention also relates to a method of operating a membrane bioreactor. The invention further relates to use of a membrane bioreactor.

### BACKGROUND

The need for sewage treatment is a matter of worldwide concern. Sewage can for example result from water use by households. Sewage can contain a wide range of chemicals, micro-organisms such as bacteria, and/or other substances that can be harmful or otherwise undesirable for humans, animals and/or the environment. Just discharging the sewage in the environment may for example lead to contamination of natural water supplies, such as surface waters and aquifers, which can be harmful to the health of humans and animals.

Treating sewage may diminish harmful or otherwise undesirable effects associated with the sewage. Known ways of treating sewage are for example based on filtering or use of biological and/or chemical processes. Such treatment of sewage normally is carried out centrally, by means of a common sewer for collecting the sewage and installations that can handle large amounts of the collected sewage. For example, the sewage produced by the households in a city can be collected centrally and treated in one and the same location.

In territories without a central sewage system, sufficient possibilities for the treatment of sewage are normally lacking. In view of the harmful effects that discharging sewage in the environment has, such territories are hindered in their development by the lack of a central sewage system. Building a central sewage system is often too expensive or may be too complicated for other reasons. For example, in some urbanized areas building a central sewage system is practically impossible, in view of the existing buildings in the urbanized areas. As another example, discharging large amounts of effluent produced by a central sewage system may be problematic.

Thus, treatment of sewage is in particular a matter of concern in territories where there is no central system for treatment of sewage. In addition, territories lacking a central sewage system often also lack a road network that is suitable for heavy transport vehicles, such as truck-trailer combinations, to pass. This further hinders the construction of a common sewer that is needed to collect the sewage at a central location where it can be treated. Moreover, the lack of a such a road network may also hinder the possibilities for transport of sufficient amounts of clean water into such territories, and/or transport of sufficient amounts of sewage out of such territories.

There thus is a need for treatment of sewage that can be applied independently from a central sewage system, in particular in territories that lack such a central system for the treatment of sewage.

### SUMMARY

The invention provides a membrane bioreactor that is arranged for treating of sewage, wherein the membrane bioreactor is arranged to be transportable and includes a first bioreaction vessel and a second bioreaction vessel, wherein the first bioreaction vessel includes a first vessel wall for enclosing a first internal vessel space, and wherein the second bioreaction vessel includes a second vessel wall for enclosing a second internal vessel space, wherein the first vessel wall includes a first peripheral vessel wall part and includes a first inner vessel wall part that is mechanically connected to the first peripheral vessel wall part, and wherein the second vessel wall includes a second peripheral vessel wall part and includes a second inner vessel wall part that is mechanically connected to the second peripheral vessel wall part, wherein the first inner vessel wall part is positioned, at least partly, opposite to the second inner vessel wall part, and wherein the first vessel wall, preferably the first inner vessel wall part, and the second vessel wall, preferably the second inner vessel wall part, are mechanically connected to each other by means of a vessel connection structure, wherein the membrane bioreactor is arranged for providing, for the treating of sewage, in the first internal vessel space an aerobic zone and in the second internal vessel space an anoxic zone, wherein the membrane bioreactor includes a fluid distribution system that is arranged for flow of sewage from the first internal vessel space, in particular from the aerobic zone, to the second internal vessel space, in particular to the anoxic zone, and/or from the second internal vessel space, in particular from the anoxic zone, to the first internal vessel space, in particular to the aerobic zone.

According to an aspect, the first peripheral vessel wall part has a convex shape and the second peripheral vessel wall part has a convex shape, and the vessel connection structure is arranged to position the convex first peripheral vessel wall part, preferably the first vessel wall, and the convex second peripheral vessel wall part, preferably the second vessel wall, relative to each other during the treating of sewage. During use of the membrane bioreactor, sewage contained in a vessel of the membrane bioreactor may form a relatively large mass. A vessel that has a wall that is at least partly convex, can withstand tensile forces relatively efficiently. As a result, such a convex wall part may be relatively thin, which in turn reduces a weight of the vessel. Reducing the weight of the membrane bioreactor may facilitate transport of the membrane bioreactor, in particular may enable transport of the membrane bioreactor into territories that lack a road network that is suitable for heavy transport to pass.

The first and second vessel both having a peripheral wall part that has a convex shape, enables a membrane bioreactor that has a relatively large first internal vessel space and a relatively large second internal vessel space, while a support structure for supporting the first and second vessel can be relatively small, in particular can have a relatively small lateral extent. A relatively small support structure may facilitate transport of the membrane bioreactor, e.g. transport by means of a forklift and/or a pick-up truck. Using a first peripheral vessel wall part and a second peripheral vessel wall part that both have a convex shape, is counter-intuitive, as it goes against efficient use of space when transporting large numbers of membrane bioreactors. For such efficient use of space during transport, a flat outer shape of a membrane bioreactor would be preferred, as it enables efficient packing of a large number of membrane bioreactors.

Preferably, the first vessel wall includes a first peripheral vessel wall part that has a convex shape in two mutually transverse directions, e.g. in two orthogonal directions, along the first peripheral vessel wall part. Preferably, the second vessel wall includes a second peripheral vessel wall part that has a convex shape in two mutually transverse directions, e.g. in two orthogonal directions, along the second peripheral vessel wall part.

In an embodiment, the first peripheral vessel wall part, at least partly, is shaped substantially as a part of a sphere, and/or the second peripheral vessel wall part, at least partly, is shaped substantially as a part of a sphere. Preferably, the first peripheral vessel wall part, at least partly, is shaped substantially as a half of a sphere. Preferably, the second peripheral vessel wall part, at least partly, is shaped substantially as a half of a sphere. Having the first peripheral vessel wall part and/or the second peripheral vessel wall part shaped as a part, preferably a half, of a sphere, enables a particularly good proportion between strength and weight of the respective peripheral vessel wall parts. Preferably, a majority of the first peripheral vessel wall part is shaped substantially as a part of a sphere, and/or a majority of the second peripheral vessel wall part is shaped substantially as a part of a sphere. In an embodiment, the first peripheral vessel wall part and the second peripheral vessel wall part extend substantially along the contour of one and the same sphere.

In an embodiment, the first and second vessel are spherically shaped at at least part of their periphery. Preferably, the first vessel and the second vessel are positioned opposite to each other, are spherically shaped at at least part of their periphery while the opposite internal vessel wall parts are mutually connected by the vessel connection structure.

In an embodiment, the first peripheral vessel wall part and the second peripheral vessel wall part have a similar shape. In this way, a weight distribution of the membrane bioreactor can be balanced, in particular during use of the membrane bioreactor. Preferably, the first peripheral vessel wall part and the second peripheral vessel wall part have a similar weight, in particular when containing sewage during use of the membrane bioreactor.

Preferably, the vessel connection structure extends from the first inner vessel wall part to the second inner vessel wall part. The vessel connection structure may enable an efficient way of positioning the first vessel wall and the second vessel wall relative to each other. The vessel connection structure preferably defines a distance from the first inner vessel wall part to the second inner vessel wall part.

In an embodiment, the vessel connection structure includes at least one vessel connection element arranged to position the first peripheral vessel wall part, preferably the first vessel wall, and the second peripheral vessel wall part, preferably the second vessel wall, relative to each other. Preferably, the vessel connection structure includes a plurality, in particular at least three or at least four, vessel connection elements that are arranged to position the peripheral first vessel wall part, preferably the first vessel wall, and the peripheral second vessel wall part, preferably the second vessel wall, relative to each other. Preferably, each vessel connection element of the plurality of vessel connection elements forms a mechanical connection from the first vessel wall, preferably from the first inner vessel wall part, to the second vessel wall, preferably to the second inner vessel wall part, that is separate from the other vessel connection elements of the plurality of vessel connection elements. The plurality of vessel connection elements preferably are spaced apart from each other. As a result, effective positioning of the first and second vessel wall relative to each other may be achieved with a relatively light vessel connection structure.

In an embodiment, at least 70 weight percent of the first vessel wall, and/or at least 70 weight percent of the second vessel wall, is made of polyethylene, in particular low density polyethylene. Polyethylene may offer a relatively good proportion between strength and weight. Preferably, a thickness of the first vessel wall, in particular the peripheral part thereof, is at least 4 millimetre and/or at most 12 millimetre, e.g. approximately 6 millimetre or approximately 8 millimetre. Preferably, a thickness of the second vessel wall, in particular the peripheral part thereof, is at least 4 millimetre and/or at most 12 millimetre, e.g. approximately 6 millimetre or approximately 8 millimetre.

According to another aspect, the first inner vessel wall part is, at least partly, spaced apart from the second inner vessel wall part so that the first inner vessel wall part and the second inner vessel wall part define an inner reactor space, e.g. a shape and/or one or more dimensions thereof, that is in between the first bioreaction vessel and the second bioreaction vessel. In an embodiment, the first inner vessel wall part and the second inner vessel wall part are substantially flat. Preferably, the inner reactor space is substantially disc-shaped. Preferably, the first inner vessel wall part and the first peripheral vessel wall part are at opposite sides of the first bioreaction vessel. Preferably, the second inner vessel wall part and the second peripheral vessel wall part are at opposite sides of the second bioreaction vessel.

Preferably, the inner reactor space enables parts of the membrane bioreactor to be positioned therein, at least partly. Leaving space between the first inner vessel wall part and the second inner wall part to create the inner reactor space, thus surprisingly enables a better balance of the membrane bioreactor. Although a lateral extent of the membrane bioreactor is increased by means of the inner reactor space, positioning parts of the membrane bioreactor at least partly in the inner reactor space enables a balanced design of the membrane bioreactor. The improved balance facilitates transport of the membrane bioreactor. This embodiment is in particular advantageous when the first vessel wall, in particular the first peripheral vessel wall part, and the second vessel wall, in particular the second peripheral vessel wall part, have a similar shape.

In an embodiment, the vessel connection structure is provided, at least partly, in the inner reactor space that is in between the first bioreaction vessel and the second bioreaction vessel. Preferably, the first inner vessel wall part and the second inner vessel wall part are mechanically connected to each other by means of the vessel connection structure. The inner reactor space thus may enable a relatively small, and hence relatively light, vessel connection structure. Preferably, the vessel connection structure defines an extent of the inner reactor space by defining a distance between the first inner vessel wall part and the second inner vessel wall part.

In an embodiment, at least part of the fluid distribution system is provided in the inner reactor space that is in between the first bioreaction vessel and the second bioreaction vessel. Preferably, the fluid distribution system is arranged for distributing water, in particular sewage, to or from the first internal vessel space and/or to or from the second internal vessel space.

In an embodiment, the vessel connection structure includes a first vessel connection structure part that is mechanically connected to the first vessel wall and includes a second vessel connection structure part that is mechanically connected to the second vessel wall, wherein the first vessel connection structure part and the second vessel connection structure part are arranged to be mechanically coupled to each other. Optionally, the first vessel wall, in particular the first inner vessel wall part, and the first vessel connection structure are made of one piece. Optionally, the second vessel wall, in particular the second inner vessel wall part, and the second vessel connection structure are made of one piece. Preferably, the vessel connection structure includes a plurality, in particular at least three or at least four, vessel connection elements that are arranged to position the first vessel wall and the second vessel wall relative to each other. Preferably, the first vessel connection structure part and the second vessel connection structure part cooperate with each other to form the vessel connection elements.

In an embodiment, the first vessel connection structure part and the second vessel connection structure part form the plurality of vessel connection elements, wherein the first vessel connection structure part includes a plurality of first vessel coupling elements and the second vessel connection structure part includes a plurality of second vessel coupling elements. Preferably, the first vessel coupling elements are offset with respect to the second vessel coupling elements in an offset direction so that, when being coupled to each other, the first vessel coupling elements and the second vessel coupling elements overlap when seen from the offset direction. Preferably, pairs of one of the first vessel coupling elements coupled to one of the second vessel coupling elements, form at least parts of the vessel connection elements. Preferably, the offset direction is a sideward direction. Optionally, the offset direction is an upward direction. Optionally, the offset direction is inclined with respect to the horizontal direction.

In an embodiment, the plurality of first vessel coupling elements may be positioned sidewardly staggered along the upward direction and the plurality of second vessel coupling elements may be sidewardly staggered along the upward direction. Thus, in an embodiment, the plurality of first vessel coupling elements may be unaligned along the upward, e.g. vertical, direction and the plurality of second vessel coupling elements may be unaligned along the upward, e.g. vertical, direction.

In an embodiment, the first vessel is provided with a first structural element that extends in the first internal vessel space to mechanically connect the first peripheral vessel wall part to the first inner vessel wall part. In an embodiment, the second vessel is provided with a second structural element that extends in the second internal vessel space to mechanically connect the first peripheral vessel wall part to the first inner vessel wall part. The first structural element may, in use, reduce movement between the first inner vessel wall part and the first peripheral vessel wall part. The second structural element may, in use, reduce movement between the first inner vessel wall part and the first peripheral vessel wall part. By means of the first and second structural elements, a wall thickness of the first vessel and the second vessel may be reduced. Thus, despite a weight of the structural elements, a weight reduction of the first vessel and the second vessel may be achieved by means of the structural elements. Preferably, the first structural element and/or the second structural element extend in a lateral, e.g. substantially horizontal, direction. Optionally, a shape, weight, and/or dimension of the first structural element is similar to, respectively, a shape, weight, and/or dimension of the second structural element.

In an embodiment, the fluid distribution system includes an oxygen supply system that is arranged for providing oxygen to the first internal vessel space, for providing the aerobic zone in the first bioreaction vessel. The oxygen supply system preferably includes an oxygen outlet that is positioned in the first internal vessel space. Preferably, the oxygen supply system is arranged for supplying oxygen to the first internal vessel space for providing therein the aerobic zone.

In an embodiment, the fluid distribution system is arranged for providing a first circulating flow of sewage, from the first internal vessel space, preferably from the aerobic zone, to the second internal vessel space, preferably to the anoxic zone, and from the second internal vessel space, preferably from the anoxic zone, to the first internal vessel space, preferably to the aerobic zone.

In an embodiment, the fluid distribution system includes a vessel connection duct that extends from the first vessel wall to the second vessel wall. Preferably, the fluid distribution system includes a further vessel connection duct that extends from the first vessel wall to the second vessel wall. Preferably, the fluid distribution system is arranged for flow of sewage from the first internal vessel space to the second internal vessel space via the further vessel connection duct. Preferably, the fluid distribution system is arranged for flow of sewage from the second internal vessel space to the first internal vessel space via the vessel connection duct. In an embodiment, the membrane bioreactor, in particular the fluid distribution system, is arranged for providing the first circulating flow of sewage from the aerobic zone to the anoxic zone, preferably via the further vessel connection duct, and from the anoxic zone to the aerobic zone, preferably via the vessel connection duct.

In an embodiment, in use, the first circulating flow is driven by at least the oxygen supply system. Preferably, in use, the first circulating flow is directed upwards in the first internal vessel space. In particular, the first circulating flow may be caused by a lower sewage density in the first internal vessel space relative to a sewage density in the second internal vessel space, said lower sewage density in the first internal vessel space resulting from oxygen supplied by the oxygen supply system. Thus, driving the first circulating flow by means of the oxygen supply system, advantageously combines providing the aerobic zone in the first internal vessel space with flow from the first internal vessel space to the second internal vessel space. In an embodiment, the further vessel connection duct is positioned higher than the vessel connection duct. This may combine well with upward flow in the first internal vessel space driven by the oxygen supply system.

In an embodiment, the fluid distribution system includes a sewage container for collecting sewage or is provided in combination with the sewage container for collecting sewage. Preferably, the sewage container is arranged to be in fluid communication with the first vessel and/or the second vessel. Preferably, the fluid distribution system includes a pump for pumping sewage from the sewage container to the first internal vessel space and/or to the second internal vessel space. Optionally, the sewage container is formed by a septic tank. In an embodiment, the sewage container is positioned below a vertical base level, e.g. a ground level, while the first vessel and/or the second vessel are positioned above said vertical base level.

In an embodiment, the pump is a cutting pump arranged for reducing a size of solid matter contained in the sewage. Preferably, the fluid distribution system is arranged to continuously operation of the cutting pump during the treating of sewage. Preferably, the fluid distribution system is arranged for reflow of sewage via the cutting pump back to the sewage container. As a result, a continuous cutting of solid matter in the sewage may be enabled.

In an embodiment, the fluid distribution system includes a membrane filter device that includes a membrane for filtering sewage to obtain filtered water, wherein the membrane filter device has a filter sewage zone and has a filtered water zone that is separated from the filter sewage zone by means of the membrane. Preferably, the filter sewage zone has a filter sewage zone inlet and a filter sewage zone outlet. Preferably, the filter sewage zone is arranged to be in fluid communication with the anoxic zone in the first vessel and/or with the aerobic zone in the second vessel. Preferably, the fluid distribution system is arranged for flow of sewage, from the filter sewage zone outlet, to the aerobic zone and/or to the anoxic zone.

In an embodiment, the fluid distribution system includes a filter device gas supply system for providing upward flow of sewage from the filter sewage zone inlet to the filter sewage zone outlet. Preferably, the filter device gas supply system is arranged for making gas flow from the filter sewage zone inlet to the filter sewage zone outlet, said gas entraining the sewage in the filter sewage zone upwards. Such an air lift, or gas lift, of the sewage in the filter sewage zone may facilitate control and flow of the sewage through the filter sewage zone. Moreover, by means of the gas supply system, accumulation of solid matter in the filter sewage zone may be counteracted.

In an embodiment, the membrane filter device at least partly extends in the inner reactor space that is in between the first bioreaction vessel and the second bioreaction vessel. As the membrane filter device is relatively large and may be relatively heavy as a result of sewage and filtered water, placing the membrane filter device in the inner reactor space may significantly improve a balance of the membrane bioreactor.

In an embodiment, the first vessel wall has a lower first vessel wall part and an upper first vessel wall part, and the second vessel wall has a lower second vessel wall part and an upper second vessel wall part, wherein the membrane filter device has a longitudinal shape and extends in the inner reactor space from the lower first and lower second vessel wall parts to the upper first and upper second vessel wall parts. In this way, a relatively large filter area may be achieved.

In an embodiment, the membrane is formed, at least partly, by walls of a plurality of tubes. Preferably, a diameter of the plurality of tubes is at least four millimetre and/or at most ten millimetre, more preferably about six millimetre. Experiments performed indicate that satisfactory results may be obtained by using tubes with a diameter in a range from four millimetre to ten millimetre, preferably about six millimetre.

In an embodiment, the fluid distribution system is arranged for providing a second circulating flow of sewage, from the first internal vessel space and/or from the second internal vessel space, to the filter sewage zone inlet, and from the filter sewage zone outlet to the first internal vessel space and/or to the second internal vessel space. Preferably, the second circulating flow further includes flow of sewage from the second internal vessel space to the first internal vessel space. Preferably, the second circulating flow further includes flow of sewage from the second internal vessel space to the sewage zone inlet via the first internal vessel space, optionally only via the first internal vessel space. The second circulating flow preferably is driven by at least the filter device gas supply system.

According to a further aspect, the membrane bioreactor, in particular the fluid distribution system, is arranged for alternating between the first circulating flow and the second circulating flow. Preferably, the fluid distribution system includes a filter supply valve that controls flow from the first internal vessel space, preferably from the anoxic zone, to the sewage zone inlet. Preferably, the fluid distribution system is arranged for carrying out the alternating by, at least, controlling, e.g. opening or closing, the filter supply valve. Preferably, opening the filter supply valve may enable flow of sewage from the first internal vessel space, preferably from the aerobic zone, to the sewage zone inlet. Preferably, closing the filter supply valve may disable flow of sewage from the first internal vessel space, preferably from the aerobic zone, to the sewage zone inlet.

The first circulating flow does not require supply of sewage to the membrane bioreactor, while treatment of sewage that is already supplied can be maintained in the aerobic zone or in the anoxic zone. The second circulating flow enables production of filtered water. Hence, by alternating between both types of circulating flow, the membrane bioreactor may maintain under operating conditions also in periods wherein there is no, or only a little, supply of sewage to the membrane bioreactor. Said aspect, said other aspect and said further aspect can be applied individually or in any combination of two or three of said aspect, said other aspect and said further aspect, and optionally in combination with one or more embodiments, variations, or examples disclosed herein.

Preferably, the membrane bioreactor, in particular the fluid distribution system, is arranged for providing the second circulating flow of sewage from the filter sewage zone outlet to the aerobic zone and/or to the anoxic zone, and from the aerobic zone and/or the anoxic zone to the filter sewage zone inlet, said flow being driven by at least the filter device gas supply system. This second type of circulating flow may for example be applied after circulating the sewage between the aerobic zone and the anoxic zone for a while, and/or some time after starting supplying sewage to the membrane bioreactor.

In an embodiment, the fluid distribution system includes a filter device gas supply system for providing upward flow of sewage from the filter sewage zone inlet to the filter sewage zone outlet. Preferably, the fluid distribution system is arranged for the second flow of sewage from the second internal vessel space to the filter sewage zone inlet, and for flow of sewage from the filter sewage zone outlet to the first internal vessel space and/or to the second internal vessel space.

In an embodiment, the fluid distribution system is arranged for flow of sewage, from the filter sewage zone outlet to the aerobic zone and/or to the anoxic zone, via the further vessel connection duct.

The further vessel connection duct preferably has a dual purpose. Firstly, the further vessel connection duct preferably enables the first circulating flow between the first internal vessel space and the second internal vessel space. Secondly, the further vessel connection duct preferably enables the second circulating flow of sewage from the filter sewage zone outlet to the first internal vessel space, in particular to the aerobic zone therein, and/or to the second internal vessel space, in particular to the anoxic zone therein. Thus, during the second circulating flow, the further vessel connection duct preferably forms a manifold that is arranged for flow of sewage from the membrane filter device, in particular from the filter sewage zone outlet, to the first vessel and/or to the second vessel. In particular, the further vessel connection duct forms a manifold that is arranged for distributing, via the manifold, sewage from the membrane filter device to the first vessel and/or to the second vessel.

In an embodiment, the filtered water zone has a filtered water zone outlet and the fluid distribution system includes a water output container for collecting the filtered water, wherein the fluid distribution system is arranged for flow of filtered water from the filtered water zone outlet to the water output container. Thus, preferably, the water output container is arranged to be in fluid communication with the filtered water zone, in particular with the filtered water zone outlet. Preferably, the water distribution system includes a tube for transport of filtered water that extends from the filtered water zone outlet to the water output container.

In an embodiment, the filtered water zone has a filtered water zone inlet and the fluid distribution system includes a backwash fluid container that is arranged to contain a backwash fluid, wherein the fluid distribution system is arranged for flow of the backwash fluid to the filtered water zone inlet. Preferably, the fluid distribution system is arranged for providing the first circulating flow simultaneously with flow of the backwash fluid to the filtered water zone inlet. In an embodiment, the fluid distribution system includes a backwash fluid container that is arranged to contain a backwash fluid and to be in fluid communication with the filterer water zone. Preferably, the fluid distribution system is arranged for pressurising the backwash fluid contained in the backwash fluid container relative to a fluid in the filter sewage zone, so that the backwash fluid can be pressurised to flow through the membrane of the membrane filter from the filter outlet zone to the filter inlet zone. As a result of the pressurization, the backwash fluid may at least partly pass through the membrane, thus providing flow that can entrain solid matter, for example including small particles, that have accumulated near the membrane away from the membrane in the filter sewage zone. As a result of the pressurization, the at least part of the backwash fluid can be made to flow through the membrane of the membrane filter device in the filter sewage zone. In this way, a plug of the solid matter that may have accumulated in the filter sewage zone during the treating of sewage, may be effectively removed.

In an embodiment, the backwash fluid container is formed by the water output container. Thus, preferably, filtered water may be used as the backwash fluid. Optionally, a disinfectant, for example a disinfectant that contains chlorine, may be added to the backwash fluid. In an embodiment, the backwash fluid container is arranged to be in fluid communication with the water output container. Preferably, the fluid distribution system is arranged for flow of the backwash fluid to the filtered water zone inlet via the water output container.

In an embodiment, the filtered water zone inlet is formed by a part of the fluid distribution system that forms the filtered water zone outlet during flow of filtered water from the filtered water zone outlet to the water output container. Optionally, the fluid distribution system includes an output tube for flow from the filtered water zone outlet to the backwash fluid container, and vice versa. Hence, optionally, during flow from the backwash fluid container to the filtered water zone, the filter water zone outlet forms the filtered water zone inlet.

In an embodiment, the fluid distribution system includes a waste collection container for collecting solid matter contained in the sewage. Preferably, the waste collection container and/or the sewage container is arranged to be in fluid communication with the filter sewage zone. Preferably, the filter sewage zone has a further sewage zone outlet for flow of sewage containing solid matter to the waste collection container and/or to the sewage container, wherein the fluid distribution system is arranged for flow of, in particular for draining of, sewage containing solid matter from the further sewage zone outlet to the waste collection container and/or to the sewage container. Optionally, such flow of sewage with solid matter provided as a result of pressuring the filtered water zone by means of the backwash fluid. According to another option, such flow of sewage with solid matter is provided by opening a waste outlet valve that is positioned to control flow from the further sewage zone outlet to the waste collection container. Preferably, the waste outlet valve is opened while the filter sewage zone is, at least partly, filled with water, for example as a result of the second circulating flow. As a result, sewage may flow from the filter sewage zone to the waste collection container, entraining solid matter that may have accumulated in the filter sewage zone. By means of the waste collection container, sewage drained from the filter sewage zone may have to flow over a relatively small distance so that a relatively large flow rate of the drained sewage may be achieved. Thus, by using the waste collection container in addition to the sewage container, removing accumulated solid matter out of the membrane filter device may be more effective.

In an embodiment, the filter sewage zone has the further sewage zone outlet for flow of sewage containing solid matter to the waste collection container, wherein the fluid distribution system is arranged for flow of, in particular for draining of, sewage containing solid matter from the further sewage zone outlet to the sewage container, optionally via the waste collection container. In this way, the treated sewage containing the solid matter, e.g. sludge, can be brought into contact with a relatively large amount of sewage that is yet untreated. In this way anaerobic conditions may arise in the container, Such anaerobic conditions may contribute to the treatment of the sewage.

In an embodiment, the fluid distribution system is arranged for flow of sewage from the waste collection container to the sewage container. Preferably, the waste collection container is provided with an overflow duct for separating solid matter in the sewage from water in the sewage. Preferably, the overflow duct is arranged for collecting the solid matter. Preferably, the waste collection container is provided with a heating element for heating the solid matter collected in the waste collection container. Preferably, the heating element extends along and/or below a bottom of the waste collection container.

In an embodiment, the fluid distribution system includes, in the first internal vessel space and/or in the second internal vessel space, a froth removal element that has an inner element space. Preferably, in use, the froth removal element extends, partly or completely, above a water level in the first and/or second vessel space to a height that enables froth floating on the water level to flow into the internal element space. Preferably, the fluid distribution system is arranged for flow from the inner element space of the froth removal element, to the waste collection container, to the sewage container, and/or to the filter sewage zone inlet.

In an embodiment, the membrane bioreactor includes a control device. Preferably, the control device is arranged for controlling the treating of sewage. Preferably, the control device is arranged for controlling flow of water, such as sewage and/or filtered water, by means of the fluid distribution system. In particular, the control device is arranged for controlling the fluid distribution system. In an embodiment, the control device is arranged for controlling the fluid distribution system for flow of sewage, from the filter sewage zone outlet to the aerobic zone and/or to the anoxic zone, via the further vessel connection duct. Preferably, the control device is arranged for distributing the sewage between the first bioreaction vessel and the second bioreaction vessel. In an embodiment, the control device is arranged for controlling the treating of sewage and/or the control of water by means of one or more valves, one or more gas supplies, and/or one or more pumps of the fluid distribution system.

The control device preferably includes one or more sensors, e.g. one or more flow sensors, one or more sewage level sensors, one or more temperature sensors, and/or one or more one or more acidity sensors such as pH sensors. The one or more sensors may be arranged for generating a sensor signal. Preferably, the sensor signal is indicative for a flow rate in the fluid distribution system. Preferably, the sensor signal is indicative for a sewage level in the first internal vessel space and/or for a sewage level in the second internal vessel space. Preferably, the sensor signal is indicative for a sewage level in the sewage container. Preferably, the sensor signal is indicative for a temperature in the first internal vessel space and/or for a temperature in the second internal vessel space. Preferably, the sensor signal is indicative for an acidity, e.g. a pH, in the first internal vessel space and/or for an acidity, e.g. a pH, in the second internal vessel space. The control device preferably is arranged to control the treating of sewage based on the sensor signal.

In an embodiment, the control device includes a computer having an input connection and an output connection. Preferably, the input connection is arranged for receiving the sensor signal. Preferably, the output connection is arranged for communication of a control signal to the fluid distribution system, in particular to the one or more valves, one or more gas supplies, and/or one or more pumps of the fluid distribution system. The computer preferably is arranged for running a computer program that determines the control signal based on the sensor signal.

In an embodiment, the control device is arranged for controlling a sewage level in the first internal vessel space and/or in the second internal vessel space. The one or more sensors preferably include one or more sewage level sensors that are preferably positioned in the first internal vessel space, in the second internal vessel space, and/or in the sewage container. Preferably, the control device is arranged for providing the supply of sewage, e.g. via the sewage supply duct, to the first internal vessel space and/or to the internal vessel space, if a sewage level is below a lower sewage level threshold. Preferably, the control device is arranged for stopping supplying sewage to the first internal vessel space and/or to the internal vessel space, if a sewage level is above an upper sewage level threshold.

In an embodiment, the control device is arranged to alternate from the second circulating flow to the first circulating flow and/or vice versa. Preferably, the control device is arranged for controlling the filter supply valve. The alternating preferably is based on the sensor signal, in particular on a part of the sensor signal generated by the one ore more sewage level sensors positioned in the first internal vessel space, in the second internal vessel space, and/or in the sewage container. In an embodiment, the control device is arranged for alternating to the first circulating flow, e.g. by closing the filter supply valve, if the sensor signal is indicative for a sewage level in the first internal vessel space and/or in the second internal vessel space that is below the lower sewage level threshold, optionally while a sewage level in the sewage container and/or a sewage supply rate is below a lower supply boundary as well.

In an embodiment, the first internal vessel space is provided with a first neck portion that defines a shape of an upper part of the first internal vessel space. In an embodiment, the second internal vessel space is provided with a second neck portion that defines a shape of an upper part of the second internal vessel space. The first and second neck portions preferably provide an increased lateral extent of the upper parts of the first and second vessel space. The first neck portion and/or the second neck portion may e.g. provide a horizontal extent of the upper part of the first internal vessel space and/or the upper part of the second internal vessel space that is substantially constant in the vertical direction. As a result, the sewage level in said upper parts may vary proportionally, e.g. approximately linearly proportionally, to the amount of sewage supplied. The first neck portion and the second neck portion may thus enable an improved control, by means of one or more sewage level sensors, of the occupation by sewage of the first internal vessel space and/or the second internal vessel space. Additionally, an efficiency of the membrane filter device may benefit from control of the sewage level in the first internal vessel space and/or in the second internal vessel space. After all, making the sewage flow through the membrane filter device to a height that is larger than the sewage level in the first and/or second internal vessel space, may require use of an increased volumetric flow rate of gas, such as air, for driving the upward flow of sewage through the filter sewage zone. Preferably, in use, a height difference between a maximum height of the sewage flowing out of the sewage zone outlet of the membrane filter device on the one hand, and the sewage level in the first and/or second internal vessel space on the other hand, is controlled to be at most 30 centimetre, preferably at most 20 centimetre, more preferably at most 10 centimetre.

Preferably, the membrane bioreactor includes a heater and/or cooler. In an embodiment, the control device is arranged for controlling a temperature of sewage while treating the sewage, preferably by means of the heater and/or the cooler. Preferably, the control device is arranged for controlling the temperature of sewage to be at least 16 degrees Celsius and/or at most 39 degrees Celsius.

In an embodiment, the further vessel connection duct is provided with one or more valves, wherein the control device is arranged for controlling the flow of sewage through the further vessel connection duct by means of the one or more valves of the further vessel connection duct. Preferably, the further vessel connection duct is formed by a manifold, in particular an outflow manifold.

In an embodiment, the membrane filter device includes a support structure that is arranged for supporting the first vessel and the second vessel. The support structure preferably is dimensioned for transport of the membrane bioreactor by means of a forklift and/or a pickup truck. In embodiment, the membrane bioreactor is provided in combination with the pickup truck.

In an embodiment, the support structure is formed, at least, by one or more, e.g. two or three, of the sewage container, the waste waste collection container, and the water output container. In an embodiment, the support structure and one or more, e.g. two or three, of the sewage container, the waste waste collection container, and the water output container, are integrated. Preferably, the support structure includes one or more, e.g. two or three, of the sewage container, the waste waste collection container, and the water output container. Optionally, the support structure is formed at least by the sewage container and the water output container. Forming at least part of the support structure by the sewage container, the waste waste collection container, and/or the water output container, may enable an efficient use of space.

In an embodiment, the fluid distribution system includes a Bell siphon that is provided with an enclosure that separates an inner space of the Bell siphon from an outer environment of the Bell siphon. Preferably, the fluid distribution system includes an output tube that is arranged for flow of filtered water from the filtered water zone outlet to the water output container. Preferably, the Bell siphon may be positioned in between parts of the output tube, so that filtered water can flow through the Bell siphon from a first part of the output tube to a second part of the output tube. Preferably, the fluid distribution system is arranged for flow through the Bell siphon of water from the water output container to the filtered water zone, in particular to the water zone outlet, for example during a backwash. This may be enabled by means of the enclosure. As a result of the enclosure, a direction of water flow through the Bell siphon can be reversed during a backwash. Preferably, the enclosure prevents flow of water out of the enclosure during a backwash.

The invention also provides a method of operating a membrane bioreactor that is arranged to be transportable and includes a first bioreaction vessel and a second bioreaction vessel, wherein the first bioreaction vessel includes a first vessel wall and the second bioreaction vessel includes a second vessel wall, wherein the method includes: enclosing a first internal vessel space by means of the first vessel wall, and enclosing a second internal vessel space by means of a second vessel wall; providing a first peripheral vessel wall part of the first vessel wall mechanically connected to a first inner vessel wall part of the first vessel wall, and providing a second peripheral vessel wall part of the second vessel wall mechanically connected to a second inner vessel wall part of the second vessel wall; providing the first inner vessel wall part positioned opposite to the second inner vessel wall part, and providing the first vessel wall and the second vessel wall, by means of a vessel connection structure of the membrane bioreactor, mechanically connected to each other; treating the sewage by providing, by means of the membrane bioreactor, in the first internal vessel space an aerobic zone and in the second internal vessel space an anoxic zone; and treating the sewage by providing flow of sewage, by means of a fluid distribution system of the membrane bioreactor, from the first internal vessel space, in particular from the aerobic zone, to the second internal vessel space, in particular to the anoxic zone, and/or from the second internal vessel space, in particular from the anoxic zone, to the first internal vessel space, in particular to the aerobic zone.

According to an aspect, the method includes providing the first peripheral vessel wall part, preferably the first vessel wall, and the second peripheral vessel wall part, preferably the second vessel wall, positioned relative to each other by means of the vessel connection structure during the treating of sewage, wherein the first peripheral vessel wall part has a convex shape and the second peripheral vessel wall part has a convex shape. A vessel that has a peripheral wall that is at least partly convex, can withstand tensile forces relatively efficiently. As a result, such a convex wall part may be relatively thin, which in turn reduces a weight of the vessel. This may facilitate transport of the membrane bioreactor, e.g. transport by means of a forklift and/or a pick-up truck.

In an embodiment, the fluid distribution system includes an oxygen supply system, the method including: providing the aerobic zone in the first internal vessel space by means of the oxygen supply system.

In an embodiment, the method includes: providing the first inner vessel wall part, at least partly, spaced apart from the second inner vessel wall part so that the first inner vessel wall part and the second inner vessel wall part define an inner reactor space that is in between the first bioreaction vessel and the second bioreaction vessel. The inner reactor space may enable a balanced design, wherein the inner reactor space preferably enables parts of the membrane bioreactor to be positioned therein, at least partly. The improved balance may also facilitate transport of the membrane bioreactor.

In an embodiment, the method includes: providing the vessel connection structure, at least partly, in the inner reactor space that is in between the first bioreaction vessel and the second bioreaction vessel and/or providing the fluid distribution system, at least partly, in the inner reactor space that is in between the first bioreaction vessel and the second bioreaction vessel.

In an embodiment, the method includes: treating the sewage by providing, by means of the fluid distribution system, a first circulating flow of sewage, from the first internal vessel space to the second internal vessel space and from the second internal vessel space to the first internal vessel space.

In an embodiment, the fluid distribution system includes a vessel connection duct that extends from the first vessel wall to the second vessel wall and includes a further vessel connection duct that extends from the first vessel wall to the second vessel wall. Preferably, the method includes: providing, by means of the fluid distribution system, the first circulating flow of sewage from the first internal vessel space to the second internal vessel space via the further vessel connection duct and from the second internal vessel space to the first internal vessel space via the vessel connection duct. Preferably, the method includes: providing, by means of the membrane bioreactor, in particular by means of the fluid distribution system, the first circulating flow of sewage from the aerobic zone to the anoxic zone via the further vessel connection duct and from the anoxic zone to the aerobic zone via the vessel connection duct.

Preferably, the method includes driving the first circulating flow by at least the oxygen supply system. Preferably, the vessel connection duct substantially equals a sewage level in the first internal vessel space and a sewage lever in the second internal vessel space. Preferably, the further vessel connection duct is positioned higher than the vessel connection duct.

In embodiment, the fluid distribution system includes a membrane filter device that includes a membrane. Preferably, the membrane filter device has a filter sewage zone and has a filtered water zone that is separated from the filter sewage zone by means of the membrane, wherein the filter sewage zone has a filter sewage zone inlet and a filter sewage zone outlet, Preferably, the method includes filtering, by means of the membrane of the membrane filter device, sewage to obtain filtered water during flow of sewage from the filter sewage zone inlet to the filter sewage zone outlet. In an embodiment, the method includes: filtering, by means of the membrane of the membrane filter device, sewage to obtain filtered water.

Preferably, the method includes providing, by means of the fluid distribution system, flow of sewage, preferably via the further vessel connection duct, from the filter sewage zone outlet, to the first internal vessel space, in particular to the aerobic zone, and/or to the second internal vessel space, in particular to the anoxic zone. Preferably, the membrane filter device at least partly extends in the inner reactor space that is in between the first bioreaction vessel and the second bioreaction vessel.

In an embodiment, the method includes: providing, by means of the fluid distribution system, a second circulating flow of sewage, from the first internal vessel space and/or from the second internal vessel space, to the filter sewage zone inlet, and from the filter sewage zone outlet to the first internal vessel space and/or to the second internal vessel space. In an embodiment, the fluid distribution system includes a vessel connection duct that extends from the first vessel wall to the second vessel wall and includes a further vessel connection duct that extends from the first vessel wall to the second vessel wall.

In an embodiment, the fluid distribution system includes a filter device gas supply system for providing upward flow of sewage from the filter sewage zone inlet to the filter sewage zone outlet, wherein the fluid distribution system is arranged for flow of sewage from the second internal vessel space to the filter sewage zone inlet, and for flow of sewage from the filter sewage zone outlet to the first internal vessel space and/or to the second internal vessel space, the method including: providing, by means of the membrane bioreactor, the second circulating flow of sewage from the filter sewage zone to the aerobic zone and/or to the anoxic zone, and from the anoxic and/or aerobic zone to the filter sewage zone, said flow being driven at least by the filter device gas supply system. During this type of circulating flow, one or more valves of the further vessel connection duct may be opened, so as to allow flow through the further vessel connection duct.

In an embodiment, the method includes transporting the membrane bioreactor, preferably by means of a forklift and/or a pickup truck. Preferably, the method includes transporting the membrane bioreactor without using a sea container.

In an embodiment, the fluid distribution system including a backwash fluid container that contains a backwash fluid and is in fluid communication with the filtered water zone, the method including: pressuring the backwash fluid contained in the backwash fluid container relative to a fluid in the filter sewage zone, so that the backwash fluid flows through the membrane of the membrane filter from the filter outlet zone to the filter inlet zone. Preferably, the backwash fluid container is formed by the water output container.

In an embodiment, the fluid distribution system includes a waste collection container, the method including: collecting, by means of the waste collection container, solid matter contained in the sewage. Preferably, the filter sewage zone has a further sewage zone outlet for flow of sewage containing solid matter to the waste collection container and/or to the sewage container, in particular for draining sewage containing solid matter to the waste collection container and/or to the sewage container. Preferably, the further sewage zone outlet is arranged to be in fluid communication with the waste collection container and/or with the sewage container. Preferably, such fluid communication is controlled by means of a waste outlet valve of the fluid distribution system.

The invention also provides use of a membrane bioreactor according to the invention, preferably in a method according to the invention.

### BRIEF DESCRIPTION OF THE DRAWINGS

The invention will be illustrated by means of the following non-limiting drawings, wherein:

FIG. 1A schematically illustrates, in a cross section of the membrane bioreactor, a membrane bioreactor for treating sewage, in an embodiment of the invention;

FIG. 1B schematically shows a detail of the bioreactor of FIG. 1A;

FIG. 1C schematically shows a Bell siphon that is included by a fluid distribution system;

FIG. 1D schematically illustrates, in a further schematic embodiment, flow of sewage and filtered water;

FIG. 2 shows an perspective view of a membrane bioreactor, in another embodiment of the invention;

FIG. 3A shows an exploded view of a membrane bioreactor in a variation of the invention;

FIG. 3B shows the membrane bioreactor of FIG. 3A;

FIG. 3C shows a cross section of the membrane bioreactor of FIGS. 3A and 3B;

FIG. 3D shows a membrane bioreactor in another variation of the invention.

FIG. 4A shows a membrane bioreactor, in a perspective side view facing a membrane filter device of the membrane bioreactor;

FIG. 4B shows, in a perspective side view facing a membrane filter device of the membrane bioreactor, a membrane bioreactor that shares the features of the membrane bioreactor of FIG. 4A,

FIG. 5A shows a membrane bioreactor, in a perspective side view facing a control device of, in particular a computer and interface of the control device of, the membrane bioreactor;

FIG. 5B shows, in a perspective side view facing a control device of the membrane bioreactor, a membrane bioreactor that shares the features of the membrane bioreactor of FIG. 5A;

FIG. 6A shows, in an exploded view, a membrane bioreactor;

FIG. 6B shows, in an exploded view, a membrane bioreactor that shares the features of FIG. 6A, and further shows part enclosed by two opposing vessel walls and parts enclosed by a support frame; and

FIG. 7 shows, in an exploded view, a membrane bioreactor.

### DETAILED DESCRIPTION

Treatment of sewage (or, in other words, waste water) may involve the removal of various types of contaminants. Such contaminants may be organic or inorganic. Contaminants may be dissolved or dispersed in the sewage, may have separated from water of the sewage to form droplets or bigger pockets of liquid, and/or may have formed a surface layer. Examples of contaminants are chemicals such as hydrocarbons, nitrogenous compounds, and phosphorus compounds. Other examples of contaminants are microorganisms that naturally may occur, for example in human and/or animal excrements.

The invention provides a transportable, i.e. mobile, membrane bioreactor. In territories without a central sewage system, such mobility of the membrane bioreactor offers possibilities for the treatment of sewage that are normally lacking. In view of the harmful effects that discharging untreated sewage in the environment may have, the transportable membrane bioreactor may support such territories in their economic development.

Additionally, or alternatively, a transportable membrane bioreactor may also be appreciated in developed countries, like many European countries. After all, also in such countries sewage may be produced at locations where access to a central sewage system is difficult or undesirable, such as for example in rural areas. In an embodiment, a membrane bioreactor may be used to treat sewage before disposing the filtered water to a central sewage system. A surprisingly advantageous application that may be generally applicable, is to use filtered water produced by the membrane bioreactor for irrigation, for example in agriculture. The inventor discovered that matter in sewage that survives the treatment by means of the membrane bioreactor (such as, for example, relatively small dissolved molecules), may be beneficial for plant growth. Experiments carried out by the inventor for example yielded filtered water containing phosphates.

A membrane bioreactor combines filtering by means of a membrane with the use of biological treatment of the sewage. In order to achieve such biological treatment, various kinds of treatment microorganisms, such as bacteria, protozoa, and/or metazoa, may be added to the sewage. For example, the treatment microorganisms may include added nitrifying bacteria and denitrifying bacteria. Such additions promote, or enable, biodegradation of contaminants that may be present in the sewage. Alternatively, or additionally, such treatment microorganisms are naturally present in the sewage. In order to have an effective biodegradation, the sewage is treated under different conditions. These conditions may include treatment under aerobic conditions, and treatment under anoxic conditions and/or treatment under anaerobic conditions. Use of aerobic, anoxic, or anaerobic conditions in the treatment of sewage is known as such.

Under aerobic conditions, microorganisms that are present in the sewage may consume dissolved oxygen. Organic matter and nitrogen may also be consumed (also referred to as biomass destruction). Such processes may typically yield CO₂ (carbon dioxide), H₂O (water) and nitrogen compounds such as (NH₄)HCO₃ (ammonium bicarbonate) and NH₃ (ammonia). Nitrifying bacteria may be added to the sewage. Such nitrifying bacteria may typically consume NH₃ and produce H₂O, H⁺ (acid) and nitrogen compounds such as NO₃ (nitrate), using dissolved oxygen (also referred to as nitrification). Thus, under aerobic conditions, the membrane bioreactor may be arranged for biomass destruction and nitrification.

The acidic conditions that result from the nitrification process, may generally be unfavourable for the microorganisms that take care of biomass destruction and/or nitrification. Under anoxic conditions, the acidic conditions may be countered, e.g. at least partly neutralized, by decomposing the nitrogen compounds such as NO₃. Under anoxic conditions, the oxygen content is relatively low while the nitrate content is relatively high. Denitrifying bacteria may be added to the sewage. Such denitrifying bacteria may typically consume NO₃ and yield N₂ (nitrogen gas) and OH⁻ (base). The latter may, at least partly, neutralize the acidic conditions resulting from denitrification, after the sewage is brought from aerobic conditions to anoxic conditions. The anoxic conditions may generally lead to basic conditions in the anoxic zone. Thus, by treating sewage in the aerobic zone and subsequently in the anoxic zone, the sewage may change from acidic to basic, or at least to sewage that is less acidic. By repeatedly bringing the sewage from aerobic conditions to anoxic conditions, acidification can be controlled and effective removal of organic matter and nitrogen from the sewage may be established under the aerobic conditions.

In addition to, preferably repeatedly, changing the conditions of the sewage between aerobic and anoxic conditions, the sewage may also be brought under anaerobic conditions. Under anaerobic conditions, anaerobic microorganisms may decompose organic contaminants present in the sewage, typically producing CH₄ (methane gas) and CO₂ (carbon dioxide). Treatment of sewage under anaerobic conditions by anaerobic microorganisms may generally take place before and/or after treatment of sewage under aerobic conditions. Treatment of sewage under anaerobic conditions by anaerobic microorganisms may generally take place before, after, and/or during treatment of sewage under anoxic conditions.

Aerobic conditions may be defined by a concentration of oxygen dissolved in the sewage (or, in short, oxygen content). Aerobic conditions can be created by locally adding oxygen to the sewage. Locations in the membrane bioreactor where oxygen is added, in particular where the oxygen content is above a lower oxygen content threshold, may be referred to as an aerobic zone. Such a zone may be defined and/or provided around an oxygen outlet of an oxygen supply system. Said oxygen outlet may be positioned inside a vessel of the membrane bioreactor (i.e. in an internal vessel space of the membrane bioreactor), which in use may be at least partly filled with sewage. Thus, in use, the oxygen outlet may be surrounded with sewage. In the aerobic zone, in use, an oxygen content of the sewage may generally be above or equal to the, preferably predetermined, lower oxygen content threshold.

Anoxic conditions may be defined by the concentration of oxygen dissolved in the sewage, and by a concentration of nitrate dissolved in the sewage (or, in short, nitrate content). In the anoxic zone, in use, the nitrate content of the sewage may generally be above or equal to a, preferably predetermined, lower nitrate content threshold for anoxic conditions. Additionally, in the anoxic zone, in use, the oxygen content of the sewage may generally be below or equal to a, preferably predetermined, upper oxygen content threshold for anoxic conditions. Anoxic conditions can generally be created by moving the sewage out of, and preferably away from, an aerobic zone after sufficient nitrate is produced, for example by moving the sewage away from the oxygen outlet. Alternatively, or additionally, anoxic conditions can be provided by stopping, or significantly reducing, the supply of oxygen, thus gradually turning the aerobic zone and/or its surroundings into an anoxic zone. After all, aerobic bacteria may have reduced the oxygen content below the upper oxygen content threshold for anoxic condition, and may have increased the nitrate content above the lower nitrate content threshold for anoxic conditions.

Anaerobic conditions may be defined by the concentration of oxygen dissolved in the sewage. Under anaerobic conditions, in use, the oxygen content of the sewage may generally be below or equal to a, preferably predetermined, upper oxygen content threshold for anaerobic conditions. Anaerobic conditions may be created by moving away the sewage from an aerobic zone, for example by moving away the sewage from the oxygen outlet. Alternatively, or additionally, anaerobic conditions can be generated by withholding, stopping, or significantly limiting or reducing, the supply of oxygen. Anaerobic conditions may be distinguished from anoxic conditions by requiring that under anaerobic conditions, the nitrate content is below an upper nitrate content threshold.

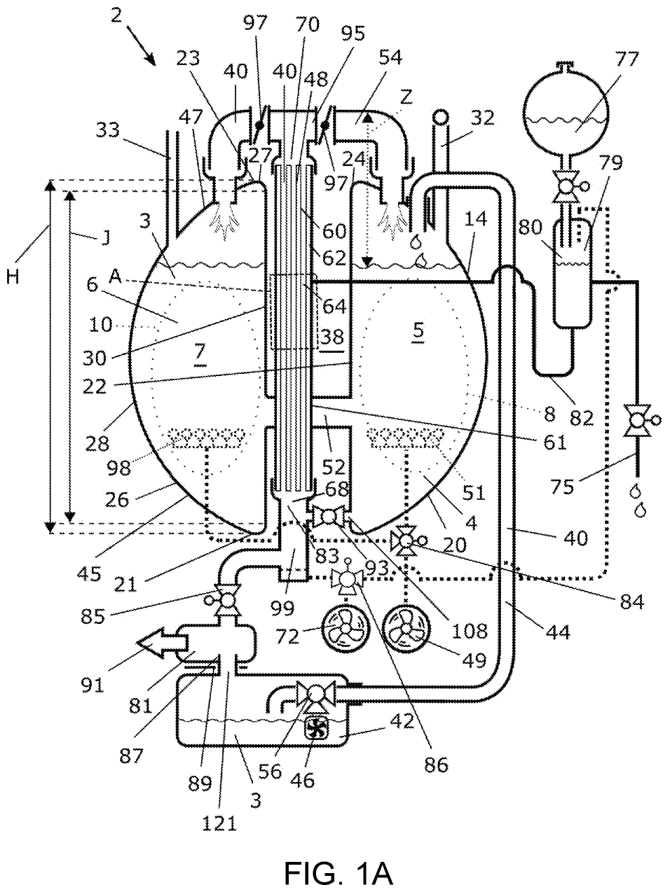

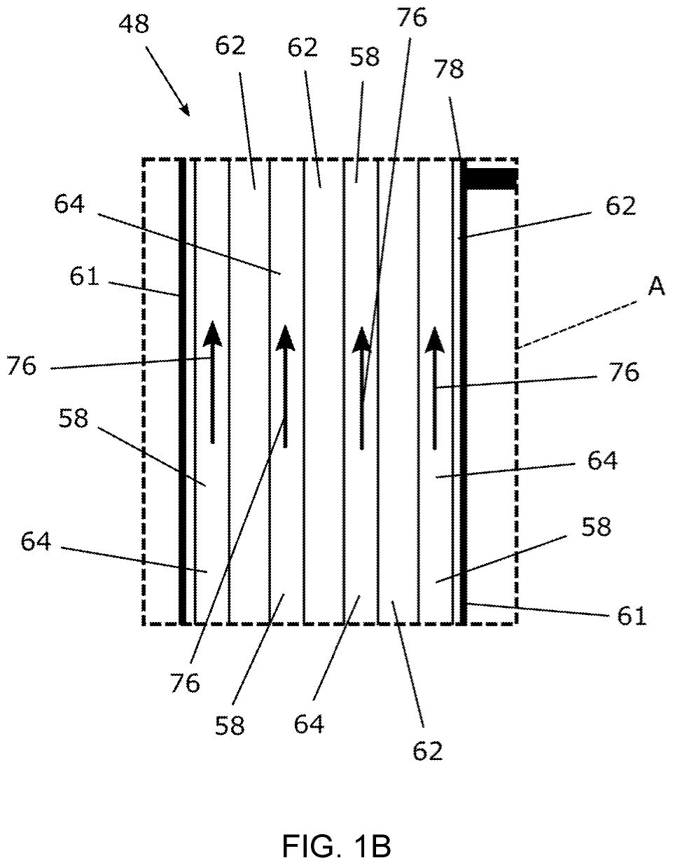

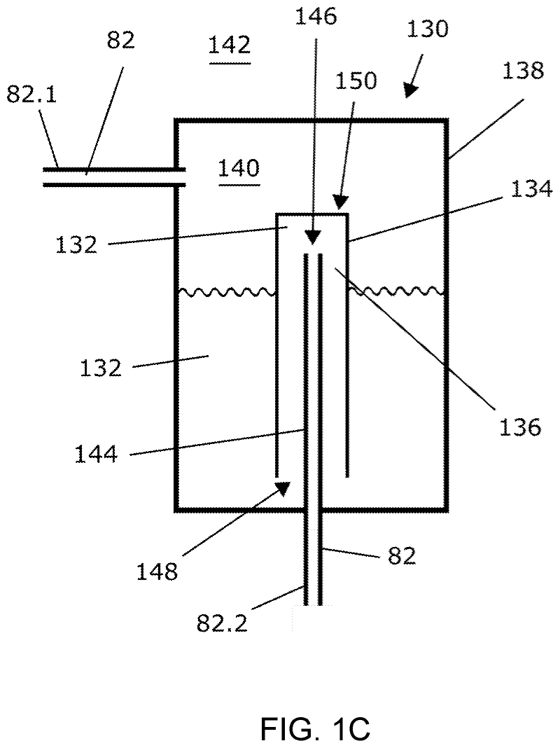

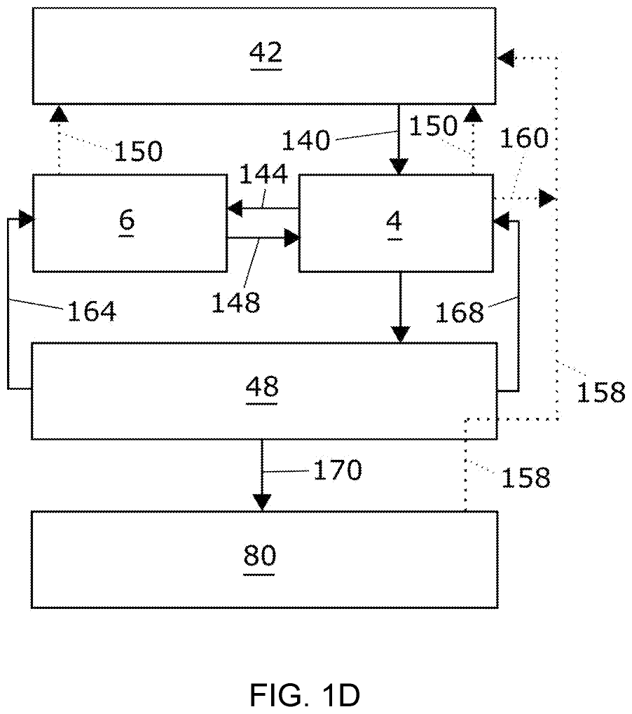

A membrane bioreactor 2 for treating of sewage 3 in an embodiment of the invention, is illustrated with reference to FIG. 1A. The membrane bioreactor is arranged to be transportable. In this embodiment, the membrane bioreactor 2 includes two bioreaction vessels, i.e. a first bioreaction vessel 4 (or, in short, first vessel 4 or vessel 4) and a second bioreaction vessel 6 (or, in short, second vessel 6 or vessel 6). The first bioreaction vessel 4 has a first internal vessel space 5. The second bioreaction vessel 6 has a second internal vessel space 7. The membrane bioreactor 2 is arranged for providing, for the treating of sewage, in the first internal vessel space 5 an aerobic zone 8 and in the second internal vessel space 7 an anoxic zone 10. Or, in other words, the first vessel 4 is arranged for housing an aerobic zone 8, and the second vessel 6 is arranged for housing an anaerobic zone or anoxic zone 10. The aerobic zone 8 may generally occupy at least 50 volume %, preferably at least 75 volume %, of the first internal vessel space 5. The anoxic zone 10 may generally occupy at least 50 volume %, preferably at least 75 volume %, of the second internal vessel space 7.

By using (at least) the two bioreaction vessels 4, 6, the aerobic zone can be effectively separated from the anoxic zone. This is especially useful for a membrane bioreactor that is transportable, as the mobility of the bioreactor may limit the volume of sewage that can be held by the membrane bioreactor. By using (at least) two bioreaction vessels, aerobic conditions may be provided in a relatively large portion, for example at least 80 volume percent, of the sewage in the first vessel 4. Similarly, anoxic conditions may be created in a relatively large portion, for example at least 80 volume percent, of the sewage in the second vessel 6. Optionally providing the membrane bioreactor with at most two bioreaction vessels, may enable a relatively simple and robust construction of the membrane bioreactor.

It may thus be clear that, generally, the aerobic zone and the anoxic zone may be provided within separate vessels. The first bioreaction vessel has the first internal vessel space and the second bioreaction vessel has the second internal vessel space. This may allow providing simultaneously relatively large volumes of sewage to either aerobic or anoxic conditions. It may moreover improve the control of the treatment of the sewage, such as repeatedly bringing volumes of sewage from aerobic to anoxic conditions or from anoxic to aerobic conditions. Although the separate vessels may be arranged to be in fluid communication with each other, using separate vessels enables a sufficient separation to create the aerobic zone (with the oxygen content above the, preferably predetermined, lower oxygen content threshold) and the anoxic zone (with the nitrogen content above the, preferably predetermined, lower nitrate content threshold for anoxic conditions). The lower oxygen content threshold may be for example 0.5 milligram per litre or 1 milligram per litre. The upper oxygen content threshold for anoxic conditions may for example be 0.2 milligram per litre or 0.5 milligram per litre. The upper oxygen content threshold for anaerobic conditions may for example be 0.1 milligram per litre or 0.3 milligram per litre. Other values for such thresholds that are known as such to the skilled person, may also be applied.

With reference to FIG. 1A, the first vessel 4 has a first vessel wall 14 for enclosing the first internal vessel space 5, in particular for enclosing the aerobic zone 8. The first vessel wall 14 includes a first peripheral vessel wall part 20 that may have a convex shape, e.g. may be formed as a part of a sphere. The first vessel wall 14 further includes a first inner vessel wall part 22. The first inner vessel wall part is connected to the first peripheral vessel wall part 20, for example by means of a first further vessel wall part 24. Alternatively, the first peripheral vessel wall part and the first inner vessel wall part may together form the first vessel wall. The first further vessel wall part 24 may be substantially circular. Optionally, the first inner vessel wall part 22 is substantially flat. The first inner vessel wall part and the first peripheral vessel wall part (or, in other words, the first outer vessel wall part) may be at opposite sides of the first bioreaction vessel.

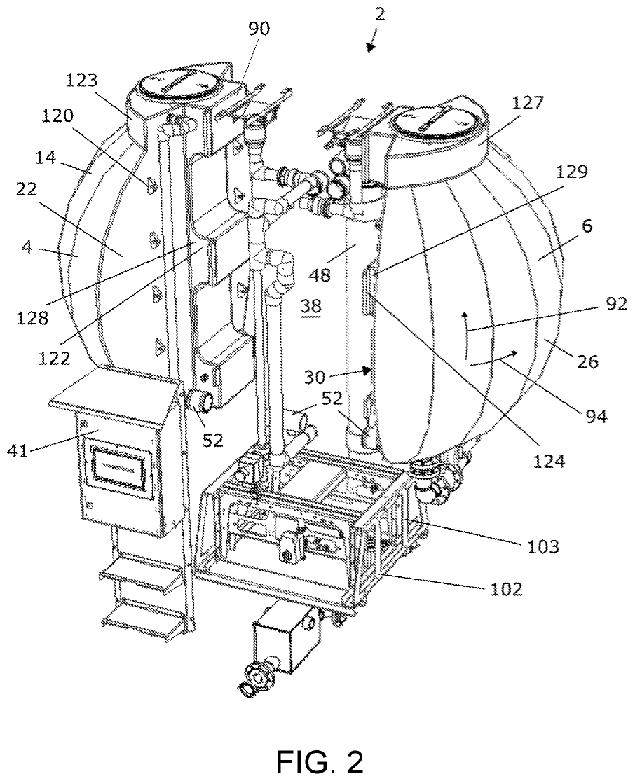

The second vessel 6 has a second vessel wall 26 for enclosing the second internal vessel space 7, in particular for enclosing the anoxic zone 10. The second vessel wall 26 includes a second peripheral vessel wall part 28 that may have a convex shape, e.g. may be formed as a part of a sphere. As is visible for example in FIG. 2, the second peripheral vessel wall part may have a convex shape in two mutually transverse directions 92, 94 along the second peripheral vessel wall part. Said two mutually transverse directions 92, 94 may for example be orthogonal directions, as illustrated in FIG. 2. Similarly, the first peripheral vessel wall part may have a convex shape in two mutually transverse directions along the first peripheral vessel wall part. The second vessel wall 26 further includes a second inner vessel wall part 30 that is connected to the second peripheral vessel wall part 28. The first inner vessel wall part 22 is positioned, at least partly, opposite to the second inner vessel wall part 30. The second inner vessel wall part 30 may be connected to the second peripheral vessel wall part 28, for example by means of a second further vessel wall part 27. Optionally, the second inner vessel wall part 30 is substantially flat. The second inner vessel wall part and the second peripheral vessel wall part (or, in other words, the second outer vessel wall part) may be at opposite sides of the second bioreaction vessel.

A height H of the second vessel wall may, more in general, be at least 1 metre and/or at most 3 metre, preferably may be in a range from 1.5 metre to 2.5 metre. The height H of the second vessel wall may be measured from a lower end 21 of the second vessel wall to an upper end 23 of the second vessel wall. A height J of the second inner vessel wall part 30 may be at least 1 metre and/or at most 3 metre, preferably may be in a range from 1.5 metre to 2.5 metre. A height of the first vessel wall may, more in general, be at least 1 meter and/or at most 3 meter, preferably may be in a range from 1.5 meter to 2.5 meter. The height of the first vessel wall may be measured from a lower end of the first vessel wall to an upper end of the first vessel wall. A height of the first inner vessel wall part may be at least 1 metre and/or at most 3 metre, preferably may be in a range from 1.5 metre to 2.5 metre.

As schematically illustrated in FIG. 1A, the first vessel wall 14, in particular the convex first peripheral vessel wall part, and the second vessel wall, in particular the convex second peripheral vessel wall part, may be shaped similarly. This enables establishing a balance between the first vessel 4 and the second vessel 6. For example, the height H of the second vessel wall may be similar to the height of the first vessel wall. As another example, the height J of the second inner vessel wall part may be similar to the height J of the first inner vessel wall part. As a further example, a volume of the first internal vessel space 5 may be similar to a volume of the second internal vessel space 7. Such dimensions may be considered similar if the larger dimension differs from the smaller dimension by at most 10% of the larger dimension.

Using a first peripheral vessel wall part and a second peripheral vessel wall part that both have a convex shape, enables a membrane bioreactor of relatively large volume and with a support that has a relatively small lateral extent, in particular a relatively small footprint. After all, the convex shape enables a width of the membrane bioreactor to increase from the support in the upward direction. This enables transport by means of relatively light equipment, such as a forklift and/or a pickup truck. Hence, the membrane bioreactor may be transported over roads of relatively poor quality. Establishing a good balance between the first vessel 4 and the second vessel 6 will be appreciated during transport of the membrane bioreactor, even when not filled with sewage. Such balance will also be appreciated during use of the membrane bioreactor, as it enables using a smaller and lighter support structure.

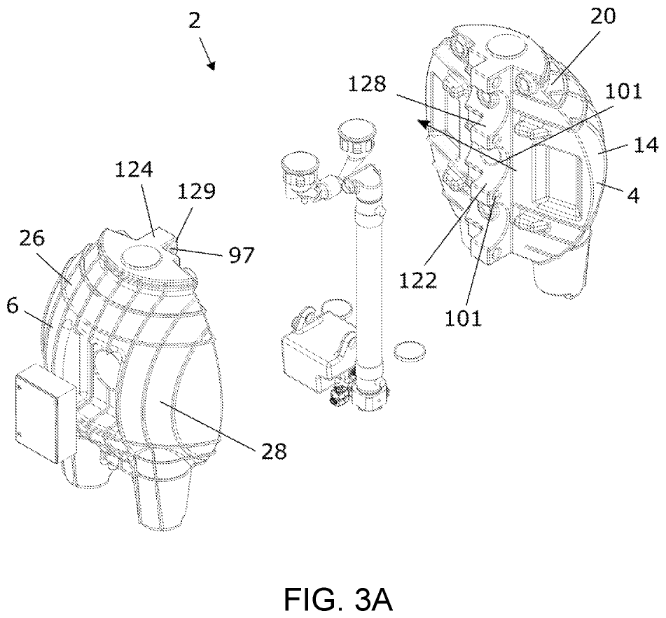

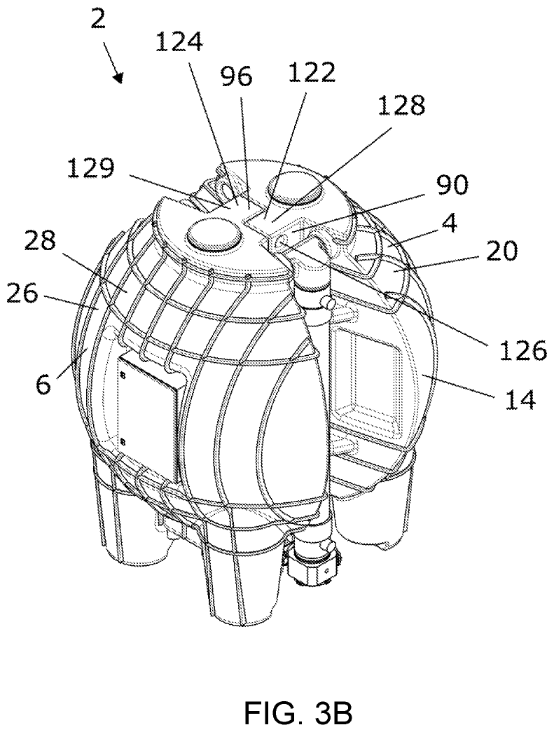

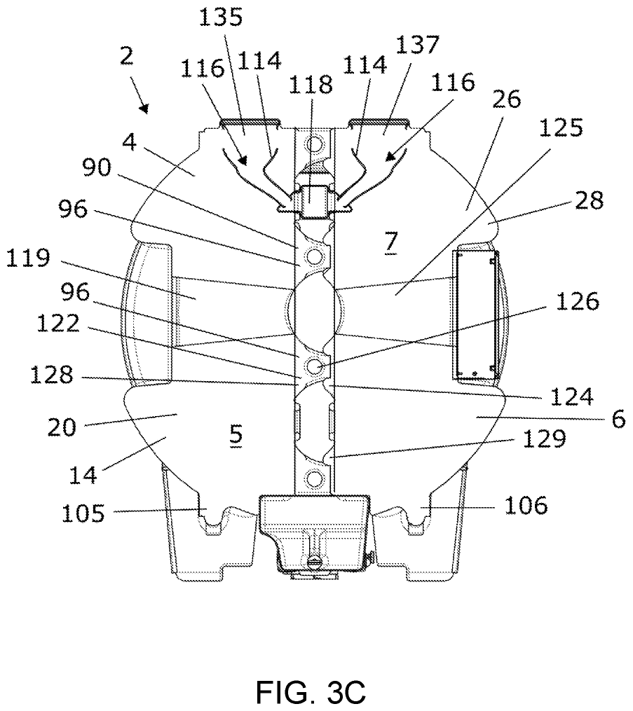

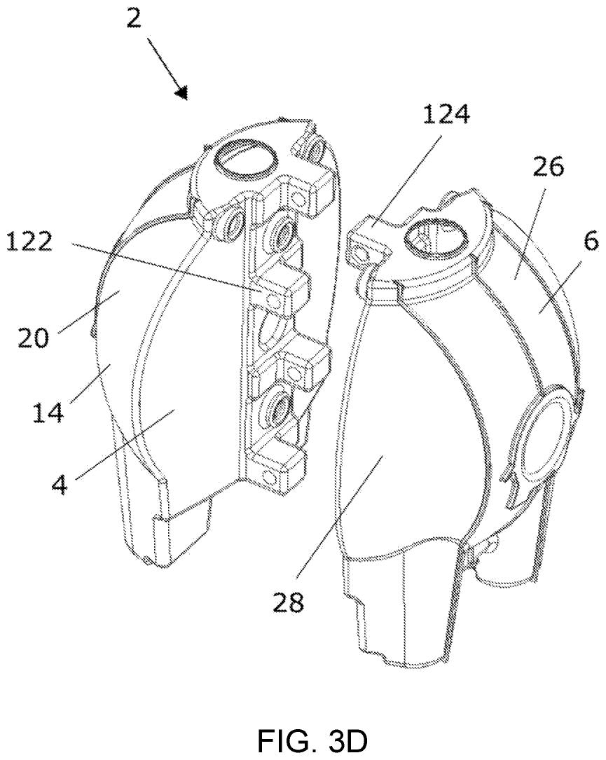

The first inner vessel wall part 22 and the second inner vessel wall part 30 may be mechanically connected to each other by means of a vessel connection structure included by the membrane bioreactor. Alternatively, or additionally, the vessel connection structure may mechanically connect, for example, another part of the first vessel wall to another part of the second vessel wall. The vessel connection structure may be provided to position the, preferably convex, first vessel wall and the, preferably convex, second vessel wall relative to each other, in particular during the treating of sewage. The vessel connection structure is not drawn in the schematic drawing of FIG. 1A, but an example of a vessel connection structure is illustrated e.g. in FIGS. 2, 3B, and 3C with reference sign go.

The membrane bioreactor includes a fluid distribution system 40. The fluid distribution system 40 may be arranged for distributing sewage to or from the first internal vessel space 5, and to or from the second internal vessel space 7. The fluid distribution system may be arranged for flow of sewage from the aerobic zone 8 to the anoxic zone 10 and/or from the anoxic zone 10 to the aerobic zone 8. Thus, the membrane bioreactor may generally be arranged for fluid communication between the aerobic zone and the aerobic zone, by means of the fluid distribution system 40.

The membrane bioreactor 2 may further include a control device. The control device may be arranged for controlling the treating of sewage by means of the membrane bioreactor. In particular, the control device may be arranged for controlling flow of water, e.g. sewage and/or filtered water, by means of the fluid distribution system 40. The control device may include one or more sensors, e.g. one or more flow sensors, one or more sewage level sensors, one or more acidity sensors, and/or one or more temperature sensors. The one or more sensors may be arranged for generating a sensor signal. The sensor signal may thus be indicative for one or more variables, such as acidity, temperature, fluid level etc. The control device may be arranged to control the treating of sewage based on the sensor signal. Such control may generally be achieved by means of one or more valves, one or more gas supplies, and/or one or more pumps, which may be included by the fluid distribution system 40.

The control device may include a computer (or, in other words, a computing device) that has an input connection and an output connection. The computer may include a mother board. The computer may include an interface that includes the input connection and the output connection. The input connection may be arranged for receiving the sensor signal. The input connection may include a plurality of electrical connections for receiving various components of the sensor signal. The output connection may be arranged for communication of a control signal to the fluid distribution system, in particular to the one or more valves, the one or more gas supplies, and/or the one or more pumps of the fluid distribution system. The output connection may include a plurality of electrical connections for output of various components of the control signal. The computer device preferably is arranged for running a computer program that determines the control signal based on the sensor signal. Thus, the control device may be arranged for controlling process equipment like the one or more valves, the one or more pumps, and the one or more gas supplies.

The fluid distribution system 40 may include an oxygen supply system 49 that is arranged for providing oxygen to the first internal vessel space. The oxygen supply system may include an oxygen outlet 51 that is positioned in the first internal vessel space 5, for providing therein the aerobic zone 8. The oxygen outlet 51 may be positioned in a lower half of the first internal vessel space 5, preferably near or at the lower end of the first vessel wall. The oxygen outlet 51 may form part of a bottom of the first vessel. Thus, by means of the oxygen supply system 49, the fluid distribution system 40 may be arranged for providing the aerobic zone 8 in the first internal vessel space 5. Preferably, the oxygen supply system is arranged for supplying oxygen to the first internal vessel space continuously (e.g. uninterruptedly for at least 5 minutes), so that sewage may be treated continuously by microorganisms that consume oxygen. In this way, treating of sewage may be carried out uninterruptedly. Moreover, in this way sludge that may have accumulated in the membrane bioreactor, e.g. in the second internal vessel space, may be prevented to settle or form discontinuities within the sludge, which could make the sludge harder to remove.

The oxygen supply system 49 may include a further gas outlet 98. The further gas outlet 98 may be arranged to supply gas, e.g. oxygen, to the second internal vessel space 7. By means of the further gas outlet 98, the fluid distribution system, in particular the oxygen supply system 49, may be arranged to toss about sludge in the second internal vessel space, e.g. by means of a short burst of gas, in particular in the anoxic zone. This may be achieved by means of oxygen or by means of another gas. Tossing up sludge may be achieved by means of gas regulating valve 84, providing a short opening for gas, e.g. oxygen, to flow to the second internal vessel space 7 via the further gas outlet 98. The gas regulating valve 84 may be a three-way valve, enabling fluid communication between the oxygen supply system 49 on the one hand, and the oxygen outlet 51 or the further gas outlet 98 on the other hand. Tossing up sludge by means of a short burst of gas may typically be carried out at least once per 5 minutes and/or at most once per 20 minutes, typically approximately once per 10 minutes.

FIG. 1A also illustrates a further embodiment that shares the features of the embodiment already described with reference to FIG. 1A. In this further embodiment, the first inner vessel wall part 22 is, at least partly, spaced apart from the second inner vessel wall part 30. As a result, the first inner vessel wall part 22 and the second inner vessel wall part 30 define an inner reactor space 38 that is in between the first vessel 4 and the second vessel 6. The first inner vessel wall part 22 and the second inner vessel wall part 30 may be substantially flat, for example with only the vessel connection structure go and ducts to or from the first internal vessel space or the second internal vessel space disturbing the first and second inner vessel wall parts. Hence, the inner reactor space may be substantially disc-shaped. Such a disc-shape may be substantially flat, and optionally has a perimeter that is substantially round. However, the disc-shape may alternatively have a perimeter with another shape.

The fluid distribution system may be provided, at least partly, in the inner reactor space 38. For example, the fluid distribution system may include a membrane filter device 48. The membrane filter device 48 may be provided, partly or completely, in the inner reactor space 38. Thus, the membrane filter device 48 may at least partly extend in the inner reactor space 38, in between the first vessel 4 and the second vessel 6. The membrane filter device 48 may have a longitudinal shape, so that at least part of it can be positioned in the inner reactor space 38. For example, a proportion between length and width of the membrane bioreactor may generally be at least five, preferably at least ten, more preferably at least fifteen.

The second vessel wall may have a lower second vessel wall part 45. The lower second vessel wall part 45 may generally extend upwards from the lower end 21 of the second vessel wall over a distance of 10%, 20%, or 30%, of the height H of the second vessel wall. The second vessel wall may have an upper second vessel wall part 47. The upper second vessel wall part may generally extend downwards from the upper end 23 of the second vessel wall over a distance of 10%, 20%, or 30%, of the height H of the second vessel wall. Similarly, the first vessel wall may have a lower first vessel wall part. The lower first vessel wall part may generally extend upwards from the lower end of the first vessel wall over a distance of 10%, 20%, or 30%, of the height of the first vessel wall. The first vessel wall may have an upper first vessel wall part. The upper first vessel wall part may generally extend downwards from the upper end of the first vessel wall over a distance of 10%, 20%, or 30%, of the height of the first vessel wall. The membrane filter device 48 may extend in the inner reactor space 38 at least from the lower first and lower second vessel wall parts to the upper first and upper second vessel wall parts. Optionally, the membrane filter device extends, upwards and/or downwards, out of the inner reactor space 38. However, preferably, at least a majority, such as at least 80% or at least go %, of a total length of the membrane filter device is within the inner reactor space. FIG. 1A shows the membrane bioreactor extending upwards slightly out of the inner reactor space 38.

The first vessel wall 14 and the second vessel wall 26 may be made of a similar material. For example, both the first vessel wall and the second vessel wall may be substantially made of polyethylene, in particular low density polyethylene (also referred to as LDPE). Preferably, at least 70 weight percent of the first vessel wall, and at least 70 weight percent of the second vessel wall, is made of polyethylene, in particular low density polyethylene. Of course, other materials that are durable, relatively light and relatively strong may be used for at least part of the first vessel wall 14 and/or at least part of the second vessel wall 26. The first vessel may be provided with a first gas release outlet 32 for flow of gas, e.g. CO₂, from the first internal vessel space to the environment. The second vessel may be provided with a second gas release outlet 33 for flow of gas, e.g. N₂, from the second internal vessel space to the environment. The first and/or second gas release outlet preferably can be sealed.

The membrane bioreactor 2 may also include an external shield such as a bioreactor housing (not illustrated in FIG. 1A). The external shield may be made substantially of aluminium and/or plastic. The external shield may be optionally applicable in embodiments of the membrane bioreactor disclosed herein. The external shield or bioreactor housing may be arranged for shielding at least the first bioreaction vessel, the second bioreaction vessel, and/or the fluid distribution system. Thus, the bioreactor housing may form a shield against influences, such as heat or cold, of the environment of the membrane bioreactor. Preferably, the shield is arranged for hindering heat and/or cold to enter inside the bioreactor housing of the membrane bioreactor. The shield may optionally be provided at a distance from the first bioreaction vessel and/or the second bioreaction vessel, preferably at a distance in a range from 3 millimetre to 6 millimetre. Preferably, air and/or isolation material is provided in between the first peripheral vessel wall part and the second peripheral vessel wall part on the one hand, and the shield on the other hand. The external shield, in particular the bioreactor housing, may enable a better control of temperature in the bioreaction vessel, in particular in the aerobic zone and in the anoxic zone. Optionally, the membrane bioreactor 2 may be arranged for flow of gas, e.g. convective flow of gas, in between the first peripheral vessel wall part and the second peripheral vessel wall part on the one hand, and the shield on the other hand. Such flow may cool the first bioreaction vessel and/or the second bioreaction vessel. The shield may optionally be provided at a distance from the first bioreaction vessel and/or the second bioreaction vessel that is arranged to enable, or cause, a convection stream in the space between the first bioreaction vessel and/or the second bioreaction vessel.

In the further embodiment, the membrane bioreactor may be provided with one with one or more handles for moving the membrane bioreactor. The first and second vessel wall, in particular the peripheral parts thereof, may be provided with the one or more handles for moving the membrane bioreactor. For example, at least one handle may be attached to the first peripheral vessel wall part and at least one handle may be attached to the second peripheral vessel wall part. Advantageously, the first peripheral vessel wall part and the at least one handle attached thereto, may be made of one piece. The second peripheral vessel wall part and the at least one handle attached thereto, may be made of one piece. The one or more handles are not drawn in FIG. 1A, but as such may be shaped conventionally. The one or more handles may e.g. be longitudinally shaped and/or may extend upwards along the first and/or second vessel wall. The one or more handles may be used for manually lifting, or in other ways moving, the membrane bioreactor. The one or more handles thus may enable users of the membrane bioreactor to move the membrane bioreactor without having to use motorized lifting equipment. The mobility of the membrane bioreactor may benefit from the one or more handles.

The fluid distribution system 40 may include a sewage container 42 for collecting sewage, e.g. from households. The sewage container may be formed by a septic tank. The sewage container may be positioned below a vertical base level such as a ground level, while the first vessel and the second vessel are positioned above said vertical base level. The sewage container may e.g. be positioned underground, partly or completely. The sewage container may be arranged to be transported together with other parts of the membrane bioreactor. Alternatively, the sewage container may be formed by a septic tank that is fixed in the ground and is not a part of the mobile membrane bioreactor. Thus, more in general, the membrane bioreactor may be provided in combination with the sewage container or may include the sewage container.

The sewage container 42 may be arranged to be in fluid communication with the first vessel 4 and the second vessel 6. Such fluid communication may be established by a sewage supply duct 44 that extends from the sewage container 42 to the first vessel 4 and/or the second vessel 6. Generally, the fluid distribution system may be arranged for flow of sewage from the sewage container 42 to the first internal vessel space 5, in particular to the aerobic zone 8, and/or to the second internal vessel space 7, in particular the anoxic zone 10. In FIG. 1A, the sewage supply duct is positioned for supply of sewage to the first internal vessel space. This may be preferred for example if the sewage in the sewage container is relatively rich in oxygen. Alternatively, or additionally, the sewage supply duct may be positioned for supply of sewage to the second internal vessel space. Supply to the second vessel space may be preferred e.g. in case of anaerobic conditions in the sewage container.

More in general, the fluid distribution system may be arranged for the supply of sewage from the sewage container to the first internal vessel space and to the second internal vessel space, dependent on the oxygen content of the sewage in the sewage container. In this way, the disturbance of anoxic conditions in the second internal vessel space as a result of the sewage supplied thereto from the sewage container, may be limited. The sewage container may have a volume of at least 400 litre and/or at most 800 litre, for example approximately 600 litre. In use, an amount of sewage in the sewage container may typically be at least 100 litre and/or at most 350 litre. A flow rate of sewage from to sewage container may be, in use, at least 0.1 cubic metre per hour and/or at most 0.3 cubic metre per hour, for example approximately 0.2 cubic metre per hour.

The fluid distribution system 40 may include a pump for pumping sewage from the sewage container 42 to the first internal vessel space 5 and/or the second internal vessel space 7. The pump may be a cutting pump 46 (or, in other words, a grinder pump) arranged for reducing a size of solid matter contained in the sewage. Typically, a particle size of a majority, e.g. 90%, of a mass of the solid matter after grinding by the cutting pump is at most 5 millimetre. Preferably, the sewage container 42 is provided with the cutting pump 46. As a result, the cutting pump 42 may be arranged for reducing a size of solid matter that may be contained in the sewage. The cutting pump 46 may be arranged for continuous flow of sewage through the cutting pump 46. As a result, a size of solid matter in the sewage may be reduced continuously, i.e. also during periods wherein no, or little, sewage flows to the first internal vessel space 5 and/or to the second internal vessel space 7. The continuous flow of sewage through the cutting pump 46 may e.g. be realised by means of a sewage supply valve 56. The sewage supply valve 56 may be a three-way valve that may be arranged for flow towards the fluid supply duct 44 or for flow back into the sewage container 42. Such flow back into the sewage container 42 may generally enable continuous operation of the cutting pump. This may reduce an average particle size of the solid matter in the sewage, may increase a lifetime of the cutting pump, and/or may reduce a start-up time for flow of sewage through the sewage supply duct 44. Thus, more in general, by means of the sewage supply valve, the fluid distribution system may be arranged for continuous flow of sewage through the cutting pump. However, alternatively, such continuous flow and flow back into the sewage container 42 may be omitted, for example in view of energy use.

The control device may be arranged to control the sewage supply valve 56 based on a part of the sensor signal that is indicative for a sewage level in the sewage container and preferably is generated by the sewage level sensor positioned in the sewage container. If the sewage level in the sewage is below a lower boundary, the sewage supply valve may be controlled to redirect the sewage displaced by the cutting pump back to the sewage container. Additionally, the control device may switch to the first circulating flow, e.g. by closing a filter supply valve 93 that controls gas flow from a filter device gas supply system 72 to the membrane filter device 48 and/or by turning of the filter device gas supply system 72. By redirecting the pumped sewage back to the sewage container, it may be prevented that the cutting pump runs dry during continuous operation.

As illustrated in FIG. 1A, the fluid distribution system 40 may be arranged for flow of sewage from the first internal vessel space 5 to the second internal vessel space 7. The fluid distribution system 40 may further be arranged for flow of sewage from the second internal vessel space 7 to the first internal vessel space 5. Thus, the fluid distribution system 40 may generally be arranged for exchange of sewage between the first internal vessel space 5, in particular the aerobic zone 8 therein, and the second internal vessel space 7, in particular the anoxic zone 10 therein. Thereto, the fluid distribution system may include a vessel connection duct 52 that extends from the second vessel wall to the first vessel wall. The first vessel 4 may be in fluid communication with the second vessel 6 by means of the vessel connection duct 52 (which may also be referred to as a sewage exchange duct). Thus, the fluid distribution system may generally include a sewage exchange duct that is arranged for fluid communication between the first internal vessel space, in particular the aerobic zone, and the second internal vessel space, in particular the anoxic zone.

The fluid distribution system 40 may further include a further vessel connection duct 54 that extends from the first vessel wall to the second vessel wall. The fluid distribution system may thus be arranged for flow of sewage from the first internal vessel space to the second internal vessel space via the further vessel connection duct 54 and from the second internal vessel space to the first internal vessel space via the vessel connection duct 52. Flow of sewage from the first internal vessel space via the further vessel connection duct, may be facilitated by a fluid level in the first internal vessel space that corresponds with an occupation by sewage of the first internal vessel space of at least 80 volume percent or at least 90 volume percent. Such a percentage may be determined while the sewage in the first vessel is still. The control device may be provided with one or more sensors for measuring a sewage level in the first internal vessel space and/or in the second internal vessel space. By means of the one or more sensors, e.g. at least two or at least three, sensors the control device may further be arranged for measuring a sewage level in the sewage container.

The membrane bioreactor may thus be arranged for providing a first type of circulating flow of sewage (or, in other words, a first circulating flow), i.e. from the aerobic zone 8 to the anoxic zone 10 via the further vessel connection duct 54 and from the anoxic zone 10 to the aerobic zone via the vessel connection duct 52. During this type of circulating flow, the filter supply valve 93 may be closed, so that no filtering takes place. Said first circulating flow may be driven by at least the oxygen supply system 49. The oxygen outlet of the oxygen supply system may generally be positioned in a lower half of the first internal vessel space (i.e., be positioned lower than a midpoint between the lower first vessel wall end and the upper first vessel wall end). As a result of this outlet position, the oxygen supply system may typically induced an upward flow of sewage in the first internal vessel space. By increasing a sewage level in the first internal vessel space high enough, the sewage may flow to the second internal vessel space via the further connection duct 54. It may thus be appreciated that, in use, the further vessel connection duct 54 is positioned higher than the vessel connection duct 52.

As schematically illustrated for example in FIG. 1A, the sewage exchange duct 54 (or, in other words, the vessel connection duct) may extend from an opening provided in the first inner vessel wall part to an opening provided in the second inner vessel wall part. In use, the sewage exchange duct may be substantially horizontal. Preferably, in use, the sewage exchange duct may generally be positioned closer to the lower end 21 of the second vessel wall than to the upper end 23 of the second vessel wall. Likewise, the opening provided in the second vessel wall part may be provided closer to the lower end 21 of the second vessel wall than to the upper end 23 of the second vessel wall. The opening provided in the first vessel wall part may be provided closer to the lower end of the first vessel wall than to the upper end of the first vessel wall.

FIG. 1B shows a schematic close-up A of the membrane filter device 48 of the fluid distribution system 40, in the further embodiment illustrated with reference to FIG. 1A. As illustrated in FIGS. 1A and 1B, the membrane filter device 48 includes a membrane 60 for filtering sewage to obtain filtered water. The membrane 60 may be formed by the walls of a plurality of membrane tubes 58. The membrane filter device may be provided with a filter device housing 61. The membrane 60 may have a height of at least 1.5 metre, preferably at least 2 metre. Experiments performed indicate that satisfactory results may be obtained by using tubes with a diameter in a range from four or five millimetre to ten millimetre, in particular by using tubes with a diameter of approximately six millimetre. A pore size of the membrane 60 may be e.g. at most 25 nanometre, at least along a majority (such as at least 99%) of an active filtering surface of the membrane 60. The membrane filter 60 may be completely within the inner reactor space 38, or at least 80% or at least 90% of the membrane filter may be positioned in the inner reactor space 38.

The membrane filter device 48 may have a filter sewage zone 64 and may have a filtered water zone 62 that is separated from the filter sewage zone 64 by means of the membrane 60. The filter sewage zone has a filter sewage zone inlet 68 and a filter sewage zone outlet 70. The filter sewage zone 64 may be formed by, or may include, an interior of the membrane tubes 58. The filtered water zone 62 may be formed by, or may include, a space outside the membrane tubes. The space outside the membrane tubes may be closed near a top and near a bottom of the tubes 58. In this way, contamination of the filtered water by sewage may be hindered.

The filtered water zone 62 may have a filtered water zone outlet 78. As illustrated in FIG. 1A, the fluid distribution system may include a water output container 80 for collecting the filtered water. The water output container enables use of the filter water long after producing the filtered water. The fluid distribution system 40 may be arranged for flow of filtered water from the filtered water zone outlet 78 to the water output container, for example via an output tube 82 for transport of filtered water to the water output container, said tube 82 being included by the fluid distribution system 40. Thus, the water output container may be arranged to be in fluid communication with the filtered water zone outlet. The output tube 82 for transport of filtered water may extend from the filtered water zone outlet 78 to the water output container 80. The output container 80 may be provided with a water tap 75, for obtaining filter water from the water output container 80. Thus, filtered water in the water output container may form a water buffer. In this way, interruptions the water supply from the water output container may be decreased. The water output container 80 in combination with the output tube 82, may generally be formed as a syphon. In this way, entrance of air into the water zone outlet 78 may be prevented, or at least diminished. In use, an inlet of filtered water to the water output container may be positioned lower than an outlet of the water output container. A diameter or cross sectional area of the output tube may be relatively small, in order to effectively enable the output tube 82 to form a syphon. The diameter of the output tube 82 may be at least 0.5 centimetre and/or at most 2 centimetre, e.g. approximately 1.2 centimetre.

The filtered water zone 62 may further have a filtered water zone inlet. The water output container may be arranged to be in fluid communication with the filtered water zone inlet. The fluid distribution system 40 may be arranged for flow of filtered water from water output container 80 the filtered water zone inlet, for example via an inlet tube for transport of filtered water to the filter water zone inlet, said inlet tube being included by the fluid distribution system 40. Optionally the filtered water zone inlet may be formed by the filtered water zone outlet 78 and/or the inlet tube may be formed by the output tube 82. Thus, the filtered water zone outlet may also be used as inlet to the filtered water zone. Additionally, or alternatively, a filtered water zone inlet may be used that is separate from the outlet 78. The separate filtered water zone inlet may be positioned lower that the filtered water zone outlet 78. The inlet tube may be separate from the output tube 82. Preferably, a diameter or cross sectional area of the inlet tube is larger than a diameter or cross sectional area of the outlet tube. A relatively large diameter or cross sectional area of the inlet tube may be beneficial to increase a flow rate and/or pressure differential across the membrane during a backwash. The diameter of the output tube 82 may be at least 2 centimetre and/or at most 4 centimetre, e.g. approximately 2.5 centimetre. The inlet tube may be provided with a non return valve in order to block flow through the inlet tube from the filtered water zone inlet to the water output container 80.

FIG. 1C schematically shows, in use, a Bell siphon 130 that may be included by the fluid distribution system 40, in the further embodiment illustrated with reference to FIGS. 1A and 1B. The Bell siphon is provided with an enclosure 138 that separates an inner space 140 of the Bell siphon from an outer environment 142 of the Bell siphon. The Bell siphon 130 may be positioned in between parts of the output tube 82, so that filtered water can flow through the Bell siphon from a first part 82.1 of the output tube 82 to a second part 82.2 of the output tube 82. The first part 82.1 of the output tube may be attached to the enclosure 138 so that filtered water can flow from the first part of the output tube into the inner space 140 of the Bell siphon. The first part of the output tube may e.g. extend into an opening in the enclosure. The enclosure may be sealed around the first part of the output tube 82.1, e.g. by means of glue.

The second part 82.2 of the output tube may be attached to the enclosure 138 to be in fluid communication with an outflow tube 144 of the Bell siphon 130. The enclosure may e.g. be attached to, and be sealed around, the second part of the output tube. The outflow tube 144 may be arranged for downward flow and may be open at its upper end 146, so that water can flow into the outflow tube 144 to the second part 82.2 of the output tube 82. The outflow tube 144 may extend in a downward direction and may be surrounded by a surrounding tube 134 that is open at its lower end 148 and that is closed at its upper end 150. The surrounding tube 134 may enclose a space 136 in between the outflow tube and the surrounding tube. The surrounding tube may be arranged for upward flow through the enclosed space 136 to the upper end 146 of the outflow tube 144. Via the lower end 148 of the surrounding tube 134, the enclosed space 136 may be in fluid communication with the inner space 140 of the Bell siphon.

In use, filtered water 132 may flow into the inner space 140 so that a water level therein may rise. As a result, also the water level in the enclosed space 136 will rise towards the upper end of the outflow tube 144. When water starts flowing downwards through the outlet tube 144, a pressure decrease may occur above the outflow tube, so that additional water will be pushed into the enclosed space 136 and through the opening of the outflow tube 144. As a result, a continuous flow of filter water to the output container may be realised. At least, a significant proportion of the filter water that has flowed into the inner space of the Bell siphon, may flow as a continuous batch towards the water output container 80. As a result of the enclosure 138, a direction of water flow through the Bell siphon can be reversed during a backwash. The enclosure 138 may prevent flow of water out of the enclosure 138 during a backwash via the output tube 82. As a result, during a backwash filtered water can flow from the second part of the output tube 82.2, through the Bell siphon to the first part of the output tube 82.1.

In the further embodiment, the fluid distribution system 40 may be arranged for flow of sewage from the filter sewage zone outlet 70 to the aerobic zone 8 and/or to the anoxic zone 10. For example, the fluid distribution system 40 may be arranged for such flow of sewage via the further vessel connection duct. Such flow of sewage may be driven by the filter device gas supply system 72. The filter device gas supply system 72 may be arranged for providing upward flow 76 of sewage from the filter sewage zone inlet 68 to the filter sewage zone outlet 70. The sewage may be entrained upwards by the gas supplied by the filter device gas supply system 72. Such gas-driven upward flow may be referred to as gas lift or air lift. More in general, the filter sewage zone 64 may be arranged to be in fluid communication with the anoxic zone in the second vessel and/or with the aerobic zone in the first vessel.

Additionally or alternatively to the first type of circulating flow between the aerobic zone and the anoxic zone, the fluid distribution system may be arranged for a second type of circulating flow (or, in other words, a second circulating flow). The second circulating flow of sewage may be from the first internal vessel space to the filter sewage zone inlet 68 via a filter supply duct 108, and from the filter sewage zone outlet to at least the second internal vessel space. Thus, the membrane bioreactor may be arranged for providing the second circulating flow of sewage from the filter sewage zone 64 to at least the anoxic zone 10 and from the anoxic zone 10 to the filter sewage zone 64 via the aerobic zone 8. This circulating flow may be driven by the filter device gas supply system. Such second type of circulating flow may be enabled by having filter supply valve 93 opened.

During this second type of circulating flow, one or more valves 97 of the further vessel connection duct may be partially or completely closed, so as to distribute sewage, flowing out of the filter sewage zone outlet 70, between the first vessel and the second vessel in different proportions. For example, a larger portion of sewage flowing out of the filter sewage zone outlet 70 may flow to the second internal vessel space than to the first internal vessel space. Such a distribution may e.g. be applied if treatment under aerobic or anoxic conditions is applied during filtering. As another example, a larger portion of sewage flowing out of the filter sewage zone outlet 70 may flow to the first internal vessel space than to the second internal vessel space. An unequal distribution of sewage, flowing out of the filter sewage zone outlet 70, between the first and second internal vessel spaces, may cause flow of sewage from the first internal vessel space to the second internal vessel space via the vessel connection duct 52, or vice versa. In this way, flow of sewage from the aerobic zone to the anoxic zone, or vice versa, may be realised during filtering of the sewage. The distribution of sewage flowing out of the filter sewage zone outlet 70 as determined by the one or more valves 97 (or, in other words, valve system 97), may be kept substantially constant during the second type of circulating flow, e.g. may be predetermined. During the second circulating flow, a proportion of sewage flowing out of the filter sewage zone outlet 70 to the second internal vessel space, may be at least 30% and/or may be at most 70%, preferably may be approximately 50%.

Advantageously, the fluid distribution system may be arranged for alternating the first circulating flow of sewage with the second circulating flow of sewage. The control device may be arranged to alternate from the second circulating flow to the first circulating flow for example when a supply of sewage is too low, if an amount of sewage in the first internal vessel space and/or in the second internal vessel space is too low, and/or if a sewage level in the sewage container 42 is too low. Such alternating may be carried out e.g. by closing the filter supply valve 93. Additionally, the supply of oxygen to the first internal vessel space may be adjusted to drive the first circulating flow.

Alternating between the first and second circulating flow may be controlled by means of the control device. Such control preferably is based on a sensor signal generated by at least a sewage level sensor positioned in the first internal vessel space or in the second internal vessel space, and a sewage level sensor positioned in the sewage container 42. In an embodiment, the control device is arranged for alternating to the first circulating flow if the sensor signal is indicative for a sewage level in the first internal vessel space or in the second internal vessel space is below the lower sewage level threshold, and/or if a sewage level in the sewage container is below a lower boundary. Additionally to, or alternatively to, the sewage level sensor in the sewage container, a sensor that measures a sewage supply rate may be used. The control device may be arranged to switch to the first circulating flow it the sewage level in the sewage container and/or the sewage supply rate is below a lower boundary. If the amount of sewage and/or the supply rate of sewage is too low, there is the risk that the sewage level in the first and/or second vessel becomes too low. As a result, a pressure in the sewage zone inlet 68 may become too low, so that effective filtering may be disabled. Too prevent this, the control device may be arranged to alternate to the first circulating flow.

The fluid distribution system may further include a backwash fluid container 79 that is arranged to contain a backwash fluid. The fluid distribution system 40 may be arranged for flow of the backwash fluid to the filtered water zone inlet. Such flow may be achieved, or at least supported, by positioning the backwash fluid container relatively high, e.g. higher than the filtered water zone inlet. Additionally, or alternatively, the fluid distribution system may be arranged for flow of oxygen from the oxygen supply system 49 to the backwash fluid container, for pressurizing the backwash fluid. This may be achieved by means of a backwash valve, for providing a fluid connection between the oxygen supply system 49 and the backwash fluid container 79. Alternatively, or additionally, the fluid distribution system may be arranged for flow of gas from the filter device gas supply system 72 to the backwash fluid container, for pressurizing the backwash fluid. This may for example be achieved by directing gas flow from the filter device gas supply system 72 towards the backwash container, by means of the backwash valve 86 indicated in FIG. 1A. Using the filter device gas supply system 72 for driving the backwash fluid, enables using the oxygen supply system 49 for driving the first circulating flow during the backwash. Additionally, or alternatively, another pressure source may be used, such as a gas supply or a pump. It may, more in general, be appreciated however to include only one pump, i.e. cutting pump 46, in the membrane bioreactor. Driving the backwash by means of a gas supply instead of an additional pump, can be relatively light and reliable.

As a result of the pressure supplied by the oxygen supply system 49, the filter device gas supply system 72, and/or said another pressure source, at least part of the backwash fluid can be forced to flow through the membrane 60 of the membrane filter device 48 into the filter sewage zone. Thus, as a result of the pressurization, the backwash fluid may at least partly pass through the membrane, thus providing flow that can entrain solid matter that has accumulated near or in the membrane, away from the membrane in the filter sewage zone. A typical pressure in the backwash fluid container for driving the backwash, may be in a range from 0.3 bar to 0.8 bar, preferably about 0.5 bar. The entraining of solid matter by flow, e.g. caused by a backwash, for removing the solid matter, may also be referred to as a form of draining the solid matter. Thus, more in general, the fluid distribution system may be arranged for pressurising the backwash fluid contained in the backwash fluid container relative to a fluid in the filter sewage zone. Preferably, the backwash is carried out simultaneously with the first circulating flow. A backwash may typically be carried out once a week. Preferably, the filter sewage zone is substantially free of sewage during a backwash.

Various mechanisms may be identified for the accumulation of the solid matter near or in the membrane. As a first example of accumulation, small particles may attach to the membrane. Such attachment may be caused by adhesive forces between the particles and the membrane, in combination with relatively low flow velocities close to the membrane. This first type of accumulation may be referred to as fouling. As a second example of accumulation, small particles may accumulate inside the pores of the membrane. Experiments showed that for example particles that contain calcium and/or iron may block the pores of the membrane. This second type of accumulation may be caused by bacteria and/or fungi that may deposit inside the pores. As a third example of accumulation, small particles may accumulate across the inside diameter of a membrane tube 58. Thus, solid matter may substantially block flow through the membrane tube. This type of accumulation may be referred to as plug formation. As a fourth example of accumulation, solid matter may accumulate outside the membrane tubes near an entrance of the membrane tubes, in the filter sewage zone inlet 68. This type of accumulation may be referred to as bridge formation.

Although all types of accumulation may be counteracted by means of a backwash, a backwash may be particularly efficient against the second type of accumulation. The first, third and fourth type of accumulation may be counteracted by other types of draining as well. For example, accumulated solid matter may be drained by opening waste outlet valve 85, closing filter supply valve 93, and turning of the filter device gas supply system 72, so that sewage can flow downwards out of the filter sewage zone to the sewage container 42. Such downward flow may effectively remove the first, third, and fourth type of accumulation of solid matter. Draining may typically be carried out at least once per 10 minutes and/or at most once per 40 minutes, typically approximately once per 20 minutes.

The backwash fluid container 79 may be formed by the water output container 80. Thus, filtered water may be used as the backwash fluid. Optionally, an additive such as an acid or a disinfectant, for example a disinfectant that contains chlorine (e.g. sodium hypochlorite), may be supplied from an additive container 77 to filtered water in the water output container before using the filtered water as backwash fluid. As another example, citric acid may be added to the backwash fluid from the additive container 77. Using citric acid (or another acid) as an additive may remove calcium compounds that have accumulated in and around the pores of the membrane (the first and second type of accumulation). Using sodium hypochlorite (or another disinfectant) may be effective against micro organisms that have accumulated in and around the pores of the membrane (the first and second type of accumulation). The fluid distribution system may include a plurality of additive containers that are arranged for providing an additive to the backwash fluid container. The filtered water zone inlet may be formed by a part of the fluid distribution system that forms the filtered water zone outlet during flow of filtered water from the filtered water zone outlet to the water output container. Optionally, the fluid distribution system includes only a single tube for flow from the filtered water zone outlet and the backwash fluid container, and vice versa. During flow from the backwash fluid container to the filtered water zone, the filter water zone outlet may form the filtered water zone inlet. In this way, a complexity and weight of the fluid distribution system may be reduced.

The fluid distribution system may further include a waste collection container 81 for collecting sewage and/or for collecting solid matter contained in the sewage. The filter sewage zone has a further sewage zone outlet 83 for flow of sewage with solid matter that has accumulated in the filter sewage zone, to the waste collection container 81. Such flow may constitute draining of sewage containing solid matter, from the filter sewage zone to the waste collection container (or, in other words, drain container) and/or to the sewage container. Thus, the fluid distribution system may be arranged for flow of sewage from the further sewage zone outlet to the waste collection container. Such flow of solid matter may for example be provided as a result of pressuring the filtered water zone by means of the backwash fluid. The flow may be enabled by means of opening a waste outlet valve 85 that is included by the fluid distribution system 40. When closed, the waste outlet valve 85 may block flow between the further sewage zone outlet 83 and the waste collection container 81.

The fluid distribution system may be arranged for flow of sewage from the waste collection container 81 to the sewage container 42, e.g. via a discharge duct 121. The waste collection container 81 may be provided with an overflow duct 87 for separating solid matter in the sewage from water in the sewage. Such an overflow duct may e.g. be realised by having the discharge duct 121 extend upwards into the waste collection container 81. Preferably, the overflow duct is arranged for collecting the solid matter, e.g. by letting the solid matter precipitate. The waste collection container 81 may be provided with a heating element 89 for heating the solid matter collected in the waste collection container. The heating element 89 may extend along and below a bottom of the waste collection container. Alternatively, the heating element may be omitted. The waste collection container may also be provided with a ventilation duct, in order to enable exchange of gas between the waste collection container and an environment of the membrane bioreactor.

The waste collection container may be arranged for removal of the solid matter and/or sewage collected in the waste collection container, after such sewage was treated at least in the aerobic zone. Such removal is represented in FIG. 1A by arrow 91. The removal of waste and/or treated sewage from the waste collection container may be carried out manually or may be automatic. Removal may be carried out for example once in a removal period of at least 1 day and/or at most 50 days, for example approximately 7 days. Before removal of the collected solid matter and/or treated sewage collected in the waste collection container, the collected solid matter and/or treated sewage may be heated by means of the heating element. In this way, harmful microorganisms contained in the solid matter may be killed. Solid matter that flows back from the waste collection container 81 to the sewage container 42, may be grinded again by means of the cutting pump 46. Enabling part of the sewage that was already treated to flow back to the sewage container 42, may enable treatment of relatively high quality and removal of a relatively large part of organic matter from the sewage.

The fluid distribution system 40 may further be arranged for flow of, in particular for draining of, the sewage containing solid matter from the further sewage zone outlet to the sewage container, optionally via the waste collection container. The flow may for example be realised by opening waste outlet valve 85, so that sewage can flow from the filter sewage zone to the sewage container 42. Preferably, such sewage contains solid matter, such as sludge, that has accumulated in the filter sewage zone and/or in the first internal vessel space. By bringing the treated sewage containing the solid matter into contact with a relatively large amount of sewage that is yet untreated, anaerobic conditions may arise in the container. After all, the sewage and/or solid matter may be partly depleted of oxygen and nitrogen compounds, while the fresh, untreated, sewage in the sewage container may be relatively rich in such compounds. Experiments have shown that under such anaerobic conditions, bio-P bacteria may grow in the sewage in the sewage container, releasing phosphate compounds under anaerobic conditions. Experiments have shown that such bio-P bacteria may capture phosphate compounds during later stages of sewage treatment, in the first and second vessel. As the latter capture of phosphate compounds can be larger than the release of phosphate compounds in the sewage container, creating anaerobic conditions in the sewage container by draining sewage containing solid matter to the sewage container, may reduce a phosphate content of the filtered water. However, alternatively, it may also be appreciated that treatment of the sewage under aerobic conditions, in particular the nitrification, already takes place in the sewage container 42, in particular while pumping the sewage out of and back into the sewage container 42 via the sewage supply valve 56.

The fluid distribution system may include, in the first internal vessel space and/or in the second internal vessel space, a froth removal element. Froth removal elements are not shown in FIGS. 1A and 1B, but an example is shown in FIG. 3C with reference sign 114. The froth removal elements may have an inner element space 116. In use, the froth removal elements may extend above a water level in the first and second internal vessel space to a height that enables froth floating on the water level to flow into the internal element spaces 116. The fluid distribution system 40 may be arranged for flow from the inner element space of the froth removal element, to the waste collection container 81, to the sewage container 42 and/or to the filter sewage zone inlet 68. Such flow may be enabled via a froth removal manifold 118. The froth removal manifold 118 may be in fluid communication with the internal element spaces 116 and, e.g. via a froth removal duct (not drawn), with the waste collection container 81 and/or to the sewage container. The froth removal elements may be open at a top of the froth removal elements. Alternatively, or additionally, the froth removal elements 114 may be provided with wall openings (not drawn) positioned in an upper part of a wall of the froth removal elements. By means of the open top and/or the wall openings, froth may be enabled to flow into the internal element space 116 of the froth removal elements 114.

FIG. 1D schematically illustrates, in a further schematic embodiment, flow of sewage and filtered water. The embodiment of FIG. 1D may represent a configuration of the fluid distribution system, or at least a part thereof. As indicated by arrow 140, the fluid distribution system may be arranged for flow of sewage from the sewage container 42 to the first internal vessel space of the first vessel 4. After filtration by the membrane filter device 48, the filtered water may flow from the membrane filter device, in particular from the filtered water zone of the membrane filter device, to the water output container 80. Such flow is schematically indicated by arrow 170.

The control device may be arranged for regulating a sewage level in the first internal vessel space and in the second internal vessel space. In this way, froth floating on the sewage may reach the froth removal elements and may enable froth to flow away through the froth removal elements. The control device may for example be arranged for increasing the sewage level by enabling supply of sewage through the sewage supply duct 44, while disabling flow of sewage through the filter supply duct 108. As a result, the occupation by sewage of the first and second internal vessel space may increase. The control device may be provided with one or more sensors for measuring a sewage level in the first internal vessel space and/or in the second internal vessel space.

FIG. 1D also schematically illustrates the two types of circulating flow, which may occur during the treating of sewage. The first type of circulating flow may be represented by arrows 144 and 148. These arrows may for example represent flow via the vessel connection duct and the further vessel connection duct, respectively. An example of the second type of circulating flow may be represented by arrows 148, 164 and 168. Arrows 168 and 164 indicate flow from the membrane filter device 48 to the internal spaces of the first vessel and the second vessel. During the second type of circulating flow, flow 148 from the second internal vessel space to the first internal vessel space may e.g. be via the vessel connection duct 52. As an option that could be applied generally, the vessel connection duct 52 may be positioned in the lower first and second vessel wall parts, e.g. near a lower end of the first and second vessel wall. The filter supply duct 108 may be positioned for flow of sewage from the first and/or second internal vessel space to the filter sewage zone inlet 68, in particular from a region near or in the vessel connection duct 52 to the filter sewage zone inlet 68.

More in general, the fluid distribution system may also be arranged for flow of sewage that was treated in the first and/or second vessel, back to the sewage container 42. The fluid distribution system may for example be arranged for flow of fluid from the internal space 5 of the first vessel 4 and/or the internal space 7 of the second vessel 6, to the sewage container 42. Such flow is indicated by arrow 150, and may be established e.g. by means of the froth removal elements. Another way of realising flow 150 of treated sewage back to the sewage container, may be by backwash from the water output container 80. Such flow is indicated by arrow 158. Yet another way of realising flow of treated sewage back to the sewage container 42, may be via a further discharge duct from the first internal vessel space to the sewage container 42. Flow via such a further discharge duct is schematically indicated by arrow 160. The further discharge duct may e.g. be formed by the further manifold 99 and discharge duct 121 (both indicated in FIG. 1A), in combination with waste outlet valve 85 and filter supply valve 93 being opened so that sewage can flow from the first internal vessel space to the sewage container 42.

FIG. 2 shows, in a schematic exploded view, a membrane bioreactor 2 in an embodiment of the invention. The membrane bioreactor may include a support structure 102 that is arranged for supporting the first vessel 4 and the second vessel 6. The support structure 102 may be formed by a support frame 103 (or, in other words, a subframe). The support structure 102, in particular the support frame 103, may be dimensioned for transport of the membrane bioreactor by means of a forklift and/or a pickup truck. FIG. 2 also illustrates an example of the membrane filter device 48 that has a longitudinal shape and is positioned in the inner reactor space 38, as well as an example of the vessel connection duct 52.

As shown in FIG. 2, the vessel connection structure 90 may be provided, at least partly, in the inner reactor space 38. The first inner vessel wall part 22 and the second inner vessel wall part 30 may be mechanically connected to each other by means of the vessel connection structure go. The vessel connection structure 90 may extend from the first inner vessel wall part 22 to the second inner vessel wall part 30. The vessel connection structure 90 provides an effective way of positioning the first vessel wall 14 and the second vessel wall 26 relative to each other. The vessel connection structure 90 may define a distance between the first inner vessel wall part 22 and the second inner vessel wall part 30. Thus, a separation between the first inner vessel wall part 22 and the second inner vessel wall part 30 may be determined by the vessel connection structure go.

The vessel connection structure 90 may include at least one vessel connection element that is arranged to position the first vessel wall 14 and the second vessel wall 26 relative to each other. Vessel connection elements may each form a mechanical connection between the first vessel wall and the second vessel, and are illustrated for example in FIGS. 3B and 3C with reference number 96. As vessel connection element may include a first vessel coupling element 122 formed by a first vessel connection structure part 128, and may include a second vessel coupling element 124 formed by a second vessel connection structure part 129. A pair of a first vessel coupling element 122 and a second vessel coupling element 124 may be arranged to engage each other to form one of the vessel connection elements 96. As shown in FIG. 2, the first vessel coupling element 122 and the second vessel coupling element 124 of said pair may both extend from respectively the first inner vessel wall part and the second inner vessel wall part. Alternatively, one of the vessel coupling elements 122, 124 of said pair may form a recess in the first or second inner vessel wall part. Preferably, the vessel connection structure go includes a plurality, in particular three or four, vessel connection elements that are arranged to position the first vessel wall and the second vessel wall relative to each other. The plurality of vessel connection elements preferably are spaced apart from each other. Each vessel connection element of said plurality may form a mechanical connection between the first vessel wall and the second vessel wall that is separate from the other vessel connection elements of said plurality. As a result, effective positioning of the first and second vessel wall relative to each other may be achieved with a relatively light vessel connection structure.

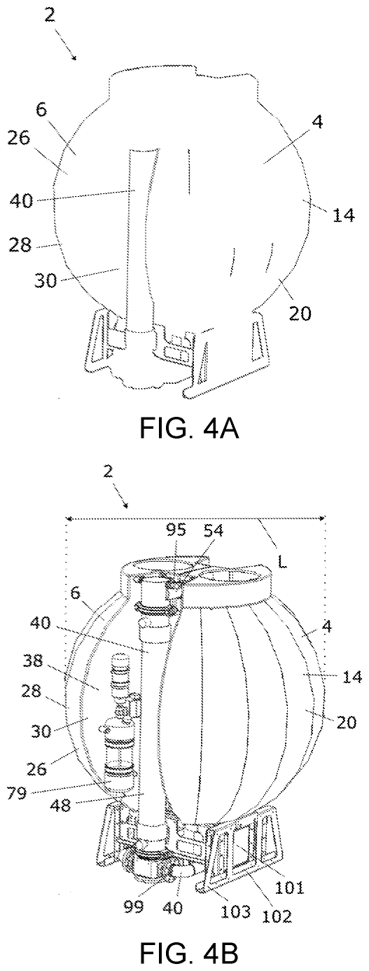

A maximum lateral extent of the membrane bioreactor may generally be at least 1 metre and/or at most 3 metre, preferably at least 1.5 metre and/or at most 2 metre, for example about 1.7 metre. The lateral extent is not indicated in FIG. 2, but is indicated in FIG. 4B with reference sign L. The lateral extent may be similar to the height of the first and/or second vessel wall. The first vessel wall 14 may be provided with a first neck portion 123 that, at least partly, defines a shape of an upper part of the first internal vessel space. The second vessel wall 26 may be provided with a second neck portion 127 that, at least partly, defines a shape of an upper part of the second internal vessel space. Examples of the first and second neck portion are illustrated in FIG. 2, while FIG. 3C illustrates the corresponding upper parts 135, 137 of the first and second internal vessel space. The upper part 135 of the first internal vessel space may be enclosed by the upper first vessel wall part, in particular by the first neck portion. The upper part 137 of the second internal vessel space may be enclosed by the upper second vessel wall part 47 (indicated in FIG. 1A), in particular by the second neck portion.

The neck portions 123, 127 may provide an increased lateral, e.g. horizontal, extent of the upper parts of the first and second internal vessel spaces. The first neck portion and/or the second neck portion may e.g. provide a horizontal extent of the upper part of, respectively, the first internal vessel space and/or the second internal vessel space that is substantially constant along the vertical direction. As a result, the sewage level in said upper parts may vary proportionally, e.g. approximately linearly proportionally, to the amount of sewage supplied. The first neck portion and the second neck portion may thus enable an improved control by means of sewage level sensors of the occupation by sewage of the first internal vessel space and the second internal vessel space.

For example, the control device may be arranged for controlling a sewage level in the first internal vessel space and/or in the second internal vessel space. Thereto, the control device may include one or more sewage level sensors that are positioned in the upper part 135 of the first internal vessel space and in the upper part 137 of the second internal vessel space. The control device may be arranged for supplying sewage, e.g. via the sewage supply duct 44, to the first internal vessel space and/or to the second internal vessel space, if a sewage level is below a lower sewage level threshold. The control device may be arranged for stopping supplying sewage to the first internal vessel space and/or to the second internal vessel space, if a sewage level is above an upper sewage level threshold. The lower sewage level threshold and the upper sewage level threshold may be positioned in the in the upper part 135 of the first internal vessel space and/or in the upper part 137 second internal vessel space.

Thus, more in general, the lower sewage level threshold and/or the upper sewage level threshold may, in use, be positioned at a similar height as, respectively, the first neck portion and/or the second neck portion. Preferably, a vertical distance between the lower sewage level threshold and the upper sewage level threshold is at least 5 centimetre or at least 10 centimetre, at least during some periods of treating sewage. This vertical distance may provide a buffer that enables control of the sewage level wherein the cutting pump 46 may continuously supply sewage to the first internal vessel space and/or to the second internal vessel space. Suddenly having to stop the pump because the sewage level rises too far, may thus be prevented. A lifetime of the cutting pump 46 may benefit from said buffer.

In use, in particular during the second type of circulating flow, a height difference Z (indicated in FIG. 1A) between a maximum height of the sewage flowing out of the sewage zone outlet of the membrane filter device on the one hand, and the sewage level in the first and/or second internal vessel space on the other hand, may be controlled by the control device to be at most 30 centimetre, preferably at most 20 centimetre, more preferably at most 10 centimetre. In use, the height difference Z for example is at most 5 centimetre. The maximum height of the sewage flowing out of the sewage zone outlet, may e.g. be a sewage level in the further vessel connection duct (which is filled with sewage in the illustration of FIG. 1A). An efficiency of the membrane filter device may benefit from such control of the sewage level in the first internal vessel space and/or in the second internal vessel space. After all, making the sewage flow through the membrane filter device to a height that is much larger than the sewage level in the first and/or second internal vessel space, may require use of a relatively large volumetric flow rate of air, or another gas, for driving the upward flow of sewage through the filter sewage zone 64. For example, a decreased sewage level in the first internal vessel space 5 and/or in the second internal vessel space 7, may decrease a pressure in the filter sewage zone inlet 68 for driving upward flow in the filter sewage zone 64. An increased amount of gas in the membrane filter device may decrease a volumetric flow rate of filtered water to the water output container. After all, an increased amount of gas may diminish a contact area between the membrane and the sewage in the filter sewage zone.

FIG. 3A shows an exploded view of a membrane bioreactor 2 in a variation of the invention. FIG. 3B shows the membrane bioreactor of FIG. 3A. FIG. 3C shows a cross section of the membrane bioreactor of FIGS. 3A and 3B. The first vessel wall 14 and the second vessel wall 26 are mechanically connected to each other by means of the vessel connection structure go. The vessel connection structure is arranged to position the convex first peripheral vessel wall part 20 and the convex second peripheral vessel wall part 28 relative to each other during the treating of sewage. The vessel connection structure 90 may include a first vessel connection structure part 128 that is mechanically connected to the first vessel wall 14, and includes a second vessel connection structure part 129 that is mechanically connection to the second vessel wall 26. The first vessel connection structure part and the second vessel connection structure part are arranged to be mechanically coupled to each other. Thereto, the first vessel connection structure part 128 and the second vessel connection structure part 129 may form a plurality of the vessel connection elements 96. The first vessel connection structure part 128 may include a plurality of first vessel coupling elements 122 and the second vessel connection structure part 129 may include a plurality of second vessel coupling elements 124. Pairs of one of the first vessel coupling elements 122 and of the second vessel coupling elements 124 may together form at least part of the vessel connection elements 96. In the variation of FIGS. 3A-3C, the vessel connection elements 96 may further include a vessel coupling bar 126 that extends through a hole 100 in the first vessel coupling element and a hole 100 in the second vessel coupling element, thus forming four vessel connection elements 96. By means of the vessel connection elements 96, the first vessel wall 14 and the second vessel wall 26 may be positioned relative to each other. Thus, more in general, the vessel connection element 96 may include the first vessel coupling element 122, the second vessel coupling element 124, and a vessel coupling lock, such as the vessel coupling bar 126, that is arranged to connect the first and second vessel coupling elements to each other.

Unlike the embodiment of FIG. 2, the variation of FIGS. 3A-3C shows that the first vessel coupling elements 122 may be offset with respect to the vessel second coupling elements 124 in an offset direction 104. As a result, when the first vessel coupling elements 122 and the second vessel coupling elements 124 are coupled to each other, the first vessel coupling elements 122 and the second vessel coupling elements 124 may overlap when seen along the offset direction 104. FIG. 3D shows a membrane bioreactor in another variation of the invention. FIG. 3D shows that the plurality of first vessel coupling elements may be positioned staggered along an upward direction. Similarly, the plurality of second vessel coupling elements may be staggered along the upward direction. Thus, while in the variation of FIGS. 3A-3C the plurality of first vessel coupling elements 122 may be substantially aligned along the upward direction, in the further variation of FIG. 3D the plurality of first vessel coupling elements 122 may be unaligned along the upward direction. Similarly, while in the variation of FIGS. 3A-3C the plurality of second vessel coupling elements 124 may be substantially aligned along the upward direction, in the further variation of FIG. 3D the plurality of second vessel coupling elements 124 may be unaligned along the upward direction.

As illustrated in FIG. 3C, the first vessel 4 may be provided with a first structural element 119 that extends in the first internal vessel space 5 to mechanically connect the first peripheral vessel wall part to the first inner vessel wall part. The second vessel 6 may be provided with a second structural element 125 that extends in the second internal vessel space 7 to mechanically connect the first peripheral vessel wall part to the first inner vessel wall part. The first and second structural elements 119, 125 may add to a strength of the first and second vessel. As a result, a wall thickness of the first vessel wall and of the second vessel wall may be reduced, leading to a lighter membrane bioreactor.

The first and second structural element 119, 125 may have a similar weight, a similar shape, and/or similar dimensions. Alternatively, the first and second structural elements 119, 125 may have weights, shapes, and/or dimensions that are different from each other. For example, the shapes of the structural elements 119, 125 may be adapted to minimize a disturbance of flow patterns that may occur in the internal first respectively second vessel spaces during the treating of sewage. The first and/or second structural element may be cylindrical or cone-shaped. This may already reduce a disturbance of flow in the first vessel 4 and/or the second vessel 6. Optionally, the first and/or second structural element 119, 125 may, at least partly, have an elongated shape in an upward direction. This may in particular be appreciated for the first structural element 119, in view of the upward flow of oxygen in the internal first vessel space.

In the embodiments of FIGS. 3A-3D, the first internal vessel space may have one or more, e.g. two, first downward extensions 105 (indicated in FIG. 3C). Similarly, the second internal vessel space may gave one or more, e.g. two, second downward extensions 106. The oxygen outlet 51 may be provided, at least partly, in the one or more first downward extensions 105. The further gas outlet 98 may be provided, at least partly, in the one or more second downward extensions 106. The first downward extensions 105 may be shaped and/or dimensioned similarly to the second downward extensions 106. Alternatively, they may have different shapes and/or sizes.

In a variation of the embodiments of FIGS. 3A-3D, the support structure is formed, at least, by the sewage container and the water output container. Thus, the support structure may be formed at least by the sewage container and the water output container. The support structure may be integrated with one or more of the sewage container, the waste collection container and the water output container. Thus, the support structure may include one or more, e.g. two or three, of the sewage container, the waste waste collection container, and the water output container. Forming at least part of the support structure by the sewage container, the waste waste collection container, and the water output container, may enable an efficient use of space.

As illustrated by means of FIGS. 2-3D, the first and second peripheral vessel wall parts may both be shaped as a part of a sphere. Thus, the first vessel wall 14 may be partly spherical and the second vessel wall 26 may be partly spherical. The first peripheral vessel wall part 20 and the second peripheral vessel wall part 28 may extend substantially along the contour of one and the same sphere. Having the first peripheral vessel wall part 20 and the second peripheral vessel wall part 28 shaped as a part of a sphere, enables a particularly good proportion between strength and weight of the respective peripheral vessel wall parts 20, 28.

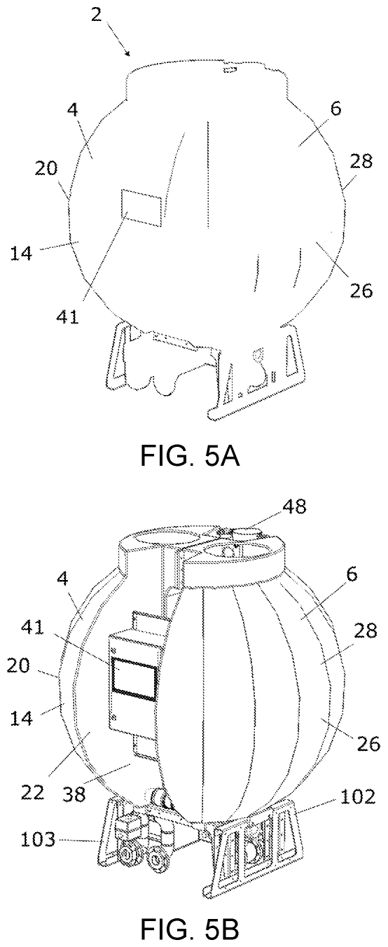

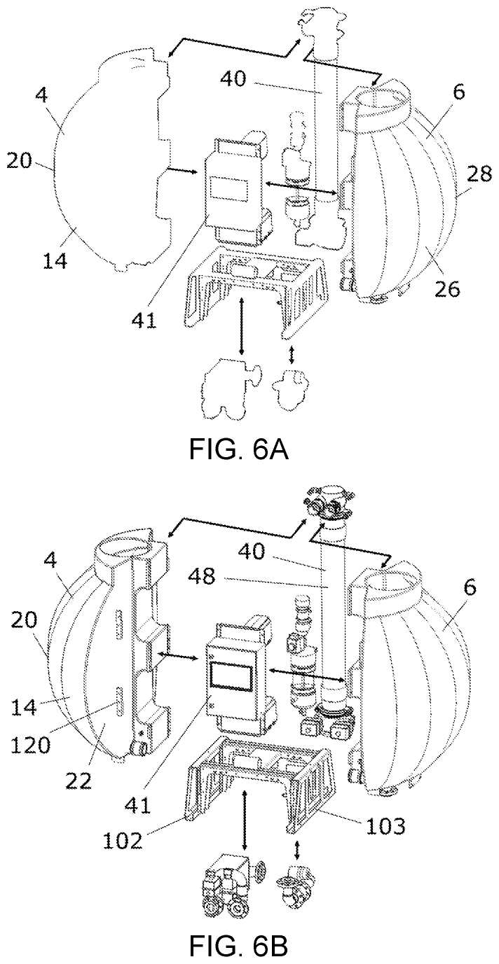

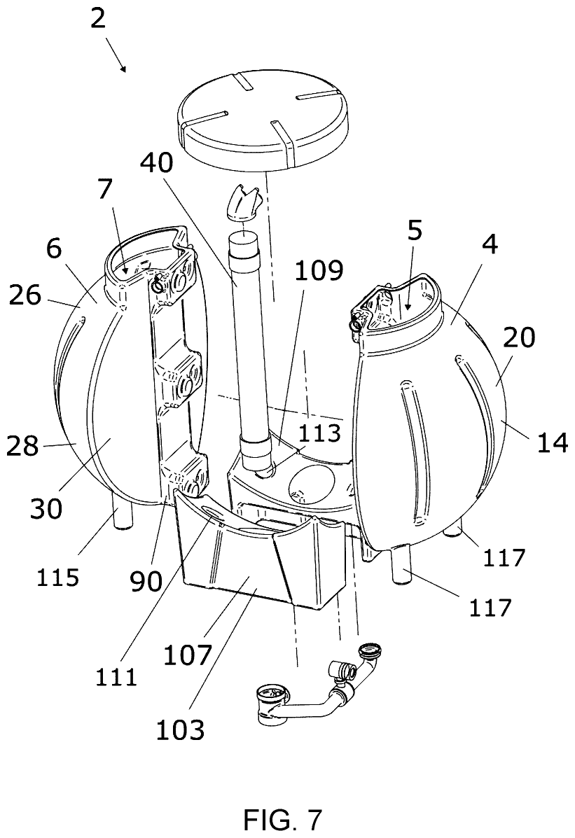

FIGS. 4A, 4B and FIGS. 5A, 5B show embodiments of a membrane bioreactor for treating sewage, in two different views. FIGS. 6A, 6B show embodiments of a membrane bioreactor in an exploded view. FIG. 7 shows another embodiment of a membrane bioreactor in an exploded view. In the embodiments of FIGS. 4B, 5B, and 6B, features are added compared to the embodiments of respectively FIGS. 4A, 5A, and 6A. Each of FIGS. 4A-7 may be considered as to relate to an individual embodiment of the invention. Nevertheless, the membrane bioreactors 2 in the embodiments of FIGS. 4A-7 do share a number of features, i.e. features that are disclosed in each of FIGS. 4A-7. In addition to the shared features, some of FIGS. 4A-7 show additional, and hence optional, features as well. In particular, FIGS. 4B, 5B, 6B and 7 show such additional features. It may thus be clear from FIGS. 3A-7 that, in addition to the shared features, also optional features may be applied to the membrane bioreactor. One or more of the optional features disclosed in, for example, FIGS. 4B, 5B, 6B, and/or 7, may optionally be applied in the embodiment of FIGS. 4A, 5A, and/or 6A. For example, one or more elements of the fluid distribution system 40 disclosed in FIG. 7, may optionally be applied in FIGS. 4A, 5A, and/or 6A. Another element from FIG. 7 that may be applied in one or more embodiments of FIGS. 4A, 5A, and 6A, is for example the vessel connection structure 90.

In the embodiments of FIGS. 4A-7, the membrane bioreactor for treating of sewage is arranged to be transportable. In addition, in the embodiments of FIGS. 4A-7 the membrane bioreactor 2 includes a first bioreaction vessel 4 and a second bioreaction vessel 6. The first bioreaction vessel 4 has a first internal vessel space 5 and the second bioreaction vessel 6 has a second internal vessel space 7. The first bioreaction vessel 4 has a first vessel wall 14 for enclosing the first internal vessel space 5. The first vessel wall 14 includes a first peripheral vessel wall part 20 and includes a first inner vessel wall part 22 that is mechanically connected to the first peripheral vessel wall part 20 (or, in other words, the first outer vessel wall part 20). The second bioreaction vessel 6 has a second vessel wall 26 for enclosing the second internal vessel space. The second vessel wall includes a second peripheral vessel wall part 28 and includes a second inner vessel wall part 30 that is mechanically connected to the second peripheral vessel wall part 28 (or, in other words, the second outer vessel wall part 28).

In the embodiments of FIGS. 4A-7, the first inner vessel wall part 22 is, at least partly, positioned opposite to the second inner vessel wall part 30. The first vessel wall 14 and the second vessel wall 26 are mechanically connected to each other by means of a vessel connection structure go. The membrane bioreactor is arranged for providing, for the treating of sewage, in the first internal vessel space 5 an aerobic zone and in the second internal vessel space 7 an anoxic zone. The membrane bioreactor includes the fluid distribution system 40 that is arranged for flow of sewage from the aerobic zone to the anoxic zone and/or from the anoxic zone to the aerobic zone.

In the embodiments of FIGS. 4A-7, the first peripheral vessel wall part 20 may have a convex shape and the second peripheral vessel wall part 28 may have a convex shape. The vessel connection structure go is arranged to position the convex first peripheral vessel wall part 20 and the convex second peripheral vessel wall part 28 relative to each other during the treating of sewage. Such positioning may for example be achieved by mechanically fixing the vessel connection structure go to the first and second inner vessel wall parts, which are mechanically connected, respectively, to the first and second peripheral vessel wall parts. In the embodiments of FIGS. 4A-7, the first inner vessel wall part 22 is, at least partly, spaced apart from the second inner vessel wall part 30 so that the first inner vessel wall part 22 and the second inner vessel wall part 30 define an inner reactor space 38, e.g. define a shape and one or more dimensions thereof. The inner reactor space 38 is in between the first bioreaction vessel 4 and the second bioreaction vessel 6.

In the embodiment of FIGS. 4A-7, the membrane bioreactor 2 may optionally include the control device 41. The control device may be arranged for controlling the treating of sewage by means of the membrane bioreactor. In particular, the control device may be arranged for controlling flow of water, e.g. sewage and/or filtered water, by means of the fluid distribution system 40. The control device may include one or more sensors, e.g. one or more flow sensors, one or more sewage level sensors, one or more acidity sensors, and/or one or more temperature sensors. The one or more sensors may be arranged for generating a sensor signal. The control device may be arranged to control the treating of sewage based on the sensor signal.

For example, a flow sensor may be provided in the filter supply duct (not shown in FIGS. 4A-7, but shown for example in FIG. 1A with reference number 108), for measuring a volumetric flow rate of sewage into the membrane filter device. The volumetric flow rate of sewage into the membrane filter device may be controlled, by means of the control device, to be at least 5 cubic metre per hour and/or at most 20 cubic metre per hour, for example be in a range from 10 to 12 cubic metre per hour. Experiments showed that such flow rates may yield satisfactory filtering, without a too fast accumulation of solid matter in the membrane filter device. More in general, the control device 41 may be arranged for controlling the fluid distribution system 40. The control device may e.g. be arranged for controlling the fluid distribution system 40 for flow of sewage, from the filter sewage zone outlet to the aerobic zone and/or to the anoxic zone, via the further vessel connection duct 54. Preferably, the control device 41 is arranged for distributing the sewage between the first vessel 4 and the second vessel 6.

The membrane bioreactor 2 may be operated according to an embodiment of a method according to the invention. An embodiment of the method may be illustrated with reference to FIGS. 1A-7. The method may alternatively be applied by means of another membrane bioreactor that is arranged to be transportable. The operated membrane bioreactor includes, at least, the first bioreaction vessel 4 and the second bioreaction vessel 6. In the illustrated embodiment the method may include transporting the membrane bioreactor. Transportation may be carried out by means of a forklift and/or a pickup truck.

The first bioreaction vessel 4 has the first internal vessel space 5 and the first vessel wall 14. The second bioreaction vessel 6 has the second internal vessel space 7 and the second vessel wall 26. The method includes enclosing the first internal vessel space 5 by means of the first vessel wall 14. The method also includes enclosing the second internal vessel space 7 by means of the second vessel wall 26. It may be clear that such enclosing is not complete, and may generally allow for example for flow of fluids out of, or into, the first internal vessel space 5 and/or the second internal vessel space 7. For example, the first gas release outlet 32 may be provided for gas exchange between the first internal vessel space 5 and an outside environment of the membrane bioreactor. As another example, the second gas release outlet 33 may be provided for gas exchange between the second internal vessel space 7 and an outside environment of the membrane bioreactor. Alternatively, or additionally, one or more ducts may be provided for exchange of fluid between the first internal vessel space and the second internal vessel space, such as the vessel connection duct 52 and the further vessel connection duct 54.

The method may include providing the first peripheral vessel wall part 20 of the first vessel wall 14 mechanically connected to the first inner vessel wall part 22 of the first vessel wall 14. The method may also include providing the first peripheral vessel wall part 20 and the second peripheral vessel wall part 28, by means of the vessel connection structure go, mechanically connected to each other. This may be achieved for example by using a membrane bioreactor 2 according to an embodiment illustrated with reference to one or more of FIGS. 1A-7. These figures illustrate the first inner vessel wall part 22 and the second inner vessel wall part 30 being mechanically connected. Alternatively, or additionally, the vessel connection structure may mechanically connect one or more other parts of the first vessel wall 14 to one or more parts of the second vessel wall 26.

Other steps of the embodiment of a method illustrated with reference to FIGS. 1A-7, may include providing the first inner vessel wall part 22 positioned opposite to the second inner vessel wall part 30. The method may further include treating sewage by providing, by means of the membrane bioreactor, in the first internal vessel space the aerobic zone 8 and in the second internal vessel space the anoxic zone 10. Treating sewage may also be carried out by providing flow of sewage, by means of the fluid distribution system of the membrane bioreactor, from the aerobic zone to the anoxic zone and/or from the anoxic zone to the aerobic zone. The method may further include providing the convex first peripheral vessel wall part and the convex second peripheral vessel wall part positioned relative to each other by means of the vessel connection structure go during the treating of sewage. The first peripheral vessel wall part 20 may have a convex shape and the second peripheral vessel wall part 28 may have a convex shape.

In a further embodiment of a method according to the invention, illustrated with reference to FIGS. 1A-7, the fluid distribution system 40 may be arranged for providing oxygen to the first internal vessel space 5. The fluid distribution system may include an oxygen supply system 49. In said further embodiment, the method may include providing the aerobic zone in the internal space 5 of the first bioreaction vessel 4 by means of the oxygen supply system 49. The first inner vessel wall part 22 may, at least partly, be spaced apart from the second inner vessel wall part 30. As a result, the first inner vessel wall part 22 and the second inner vessel wall part 30 may define the inner reactor space 38 in between the first vessel 4 and the second vessel 6. The vessel connection structure go may be provided, at least partly, in the inner reactor space 38 in between the first vessel 4 and the second vessel 6. Also, the fluid distribution system 40 may be provided, at least partly, in the inner reactor space in between the first vessel 4 and the second vessel 6.

In the further embodiment, the method may further include treating the sewage by providing, by means of the fluid distribution system 40, flow of sewage from the first internal vessel space 5 to the second internal vessel space 7 via the further vessel connection duct 54 and from the second internal vessel space 7 to the first internal vessel space 5 via the vessel connection duct 52. The method may also include treating the sewage by providing, by means of the membrane bioreactor 2, the first circulating flow of sewage from the aerobic zone to the anoxic zone via the further vessel connection duct 54 and from the anoxic zone to the aerobic zone via the vessel connection duct 52. This first type of circulating flow may be driven by at least the oxygen supply system 49. In this way, the sewage may be brought repeatedly from aerobic conditions to anoxic conditions and from anoxic conditions to aerobic conditions.

The method in the further embodiment may also include treating the sewage by filtering, by means of the membrane 60 of the membrane filter device 48, sewage to obtain filtered water (or, in other words, permeate). The membrane filter device may have the filter sewage zone 64 and the filtered water zone 62 that is separated from the filter sewage zone 64 by means of the membrane 60. The method may include providing, by means of the fluid distribution system 40, flow of sewage, from the filter sewage zone outlet 70, to the aerobic zone 8 and/or to the anoxic zone 10. Thus, sewage flowing out of the filter sewage zone 64, may be distributed between the first internal vessel space 5 and the second internal vessel space 7. The method may include providing, by means of the fluid distribution system 40, flow of sewage, from the filter sewage zone outlet 70 to the aerobic zone 8 and/or to the anoxic zone 10, via the further vessel connection duct 54. The membrane filter device may extend, at least partly, in the inner reactor space that is in between the first vessel and the second vessel.

By means of the filter device gas supply system 72, the fluid distribution system 40 may be arranged for flow of sewage from the second internal vessel space 7 to the filter sewage zone inlet 68, and for flow of sewage from the filter sewage zone outlet 70 to the second internal vessel space 7. This may enable providing, by means of the membrane bioreactor 2, the second type of circulating flow of sewage from the filter sewage zone to the anoxic zone and from the anoxic zone to the filter sewage zone, said flow being driven by the filter device gas supply system. Instead of flowing only through the anoxic zone, the sewage may optionally reach the anoxic zone via the aerobic zone, as a result of the distribution of sewage flowing out of the filter sewage zone between the first internal vessel space and the second internal vessel space.

During the first type of circulating flow, filtering of the sewage may be paused. The first type of circulating flow (or, in other words, the first circulating flow) may be directed to biomass reduction, nitrification, and denitrification. The second type of circulating flow (or, in other words, the second circulating flow) may additionally be directed to filtering. In use, the second type of circulating flow may, more in general, be applied after the first type of circulating flow. The filtered water (or, in other words, the permeate) obtained from the membrane bioreactor, may be used for a variety of purposes. In some embodiments, the filtered water can be used in agriculture, in particular for irrigation or for cattle. Alternatively, or additionally, the filtered water can be used for sanitation, such as showering, washing, cleaning etc. In some embodiments, the filtered water can be used as drinking water, e.g. for humans and/or for animals.

It may be appreciated that, in some embodiments disclosed herein, the membrane bioreactor at least partly meets a need for sewage treatment. This may be particularly relevant in territories without a central sewage system. Such countries may often also lack an extensive road network that is suitable for heavy transport to pass. There thus is a need for a transportable, or in other words mobile, sewage treatment system. The system may also be of high quality, may be sustainable, may be easily transportable by a light off-road vehicle, may be easy to install in situ, may be easy to maintain by technically unskilled users of the membrane bioreactor, may only need professional service at long time intervals, may use communication means that enable control and service via internet, may be arranged to run at low energy costs, and/or may be operated by using energy that is generated by energy generation means that are integrated with the membrane bioreactor.

In some embodiments disclosed herein, the membrane bioreactor may form an improvement over, or a least may form an alternative to, previously disclosed bioreactors, such as in U.S. Pat. No. 7,820,047, CN1318320, EP 1647530, JP 2005246308, and other publications. Some of known membrane bioreactors may require a regular need for professional maintenance, may require maintenance space, may have a high energy consumption, may have a complex configuration, may be difficult to install in situ, may depend on heavy means of transport, and/or may otherwise not form a membrane bioreactor that may be compactly assembled, may be ready to operate, and/or may form a mobile unit that is transportable by light means. In some embodiments disclosed herein, the membrane bioreactor may form an integrated unit, instead of being installed in one or more air conditioned sea containers that merely form a housing for the membrane bioreactor installation. Moreover, membrane bioreactors installed in an air-conditioned sea container usually still operate at high energy costs, still depend on heavy transport means, and still need permanent professional maintenance and control. In some embodiments, the membrane bioreactor disclosed herein at least partly meets one or more, preferably all, of such disadvantages. In some embodiments, a sustainable membrane bioreactor may be provided.

Against the background of one or more of disadvantages of known membrane bioreactors, more in general, there is further provided a membrane bioreactor that is arranged for treating of sewage. In some embodiments, the membrane bioreactor is arranged to be transportable and includes, at least, a first bioreaction vessel and a second bioreaction vessel, wherein the first bioreaction vessel has a first internal vessel space and a first vessel wall for enclosing the first internal vessel space, wherein the second bioreaction vessel has a second internal vessel space and has a second vessel wall for enclosing the second internal vessel space. In some embodiments, the first vessel wall includes a first peripheral vessel wall part and includes a first inner vessel wall part that is mechanically connected to the first peripheral vessel wall part, wherein the second vessel wall includes a second peripheral vessel wall part and includes a second inner vessel wall part that is mechanically connected to the second peripheral vessel wall part, wherein the first inner vessel wall part is positioned, at least partly, opposite to the second inner vessel wall part. In some embodiments, the first vessel wall, preferably the first inner vessel wall part, and the second vessel wall, preferably the second inner vessel wall part, are mechanically connected to each other by means of a vessel connection structure.

The membrane bioreactor is arranged for providing, for the treating of sewage, in the first internal vessel space an aerobic zone and in the second internal vessel space an anoxic zone, wherein the membrane bioreactor includes a fluid distribution system that is arranged for flow of sewage from the aerobic zone to the anoxic zone and/or from the anoxic zone to the aerobic zone. In some embodiments, the first peripheral vessel wall part has a convex shape and the second peripheral vessel wall part has a convex shape and the vessel connection structure is arranged to position the convex first peripheral vessel wall part and the convex second peripheral vessel wall part relative to each other during the treating of sewage. In some embodiments, the first inner vessel wall part is, at least partly, spaced apart from the second inner vessel wall part so that the first inner vessel wall part and the second inner vessel wall part define an inner reactor space, e.g. a shape and one or more dimensions thereof, in between the first bioreaction vessel and the second bioreaction vessel.

Thus, instead of using a known large scale membrane bioreactor for producing permeate of high quality, embodiments of the membrane bioreactor may be used that are assembled compactly, may be operated readily, and may be used for treating sewage and producing the permeate. The membrane bioreactor preferably forms a unit that is transportable by light means, such as a forklift and/or a pickup truck. In some embodiments, a membrane bioreactor, and/or a method of operating a membrane bioreactor, is provided wherein, compared to known membrane bioreactors, the membrane bioreactor and integrated parts of the membrane bioreactor are rigidly constructed, in particular by means of the vessel connection structure.

There also are provided, instead of known methods that are implemented by using a large scale membrane bioreactor that produces permeate of high quality, embodiments of a method for operating a, preferably compactly assembled, membrane bioreactor that is ready to be operated and/or forms a mobile unit that is transportable, preferably by relatively light means. In some embodiments, the membrane bioreactor is equipped to produce permeate of high quality, by means of a membrane filter device and at least two bioreaction vessels. In some embodiments, a membrane bioreactor process for treating sewage is provided that can be applied in a compactly assembled, mobile unit. Such a process may be arranged, e.g. may be scaled and integrated, for application in the membrane bioreactor. Experiments performed show that in this way, a high quality permeate can be produced, while the membrane bioreactor can be transported by light means of transport such as forklifts or pickup trucks.

Referring to FIGS. 4B, 5B, 6B, and 7, compactly assembling the membrane bioreactor may be achieved by setting up a framework that includes, or consists of, a support structure 102 that may be formed by a support frame 103, and two opposite interconnected bioreaction vessels 4, 6 that may be mounted on the support structure. The vessels 4, 6 may be mounted on the support frame 103 at a mutual distance, thereby enclosing the inner reactor space 38. Alternatively, each vessel may be combined with a part of a support frame, e.g. by being rotation moulded in one piece. This option is not illustrated in FIGS. 4B, 5B, 6B, and 7, but is illustrated for example in FIG. 3D. Optionally, the rotation moulded piece is subsequently divided into two or more pieces by using one or more partition plates. Theses pieces may be provided with connection means in order to form the framework.

Thus, the vessels 4, 6 and/or the support frame 103 may be manufactured by rotation moulding, i.e. may be rotation moulded. The support frame may optionally consist of, or comprise, two rotation moulded mechanically connected parts 107, 109 (illustrated in FIG. 7). The support frame 103, in particular each of said mechanically connected parts, may be provided with counter fittings 111, 113. The counter fittings 111, 113 may be arranged for cooperating with, e.g. for receiving, fittings 115, 117 of the vessels 4, 6. Each of the vessels 4, 6 may be provided with fittings 115, 117. The fittings of each individual vessel may be fitted to the counter fittings 111, 113 of two oppositely situated support frame parts 107, 109, thereby connecting the mounted vessels 4, 6 to the support frame parts 107, 109.

The membrane bioreactor may include other parts that may be rotation moulded and/or that are equipped to accumulate fluids, in particular liquids, such as permeate, mixed liquids from the membrane bioreactor, and/or or liquids to be treated by another water treatment. Another water treatment may e.g. comprise an ultra violet treatment, a coagulation treatment, and/or an active coal treatment. Such other water treatment may be performed by another water treatment system. Alternatively, or additionally, the membrane bioreactor may be arranged for performing such other water treatment.

The support frame 103 may enclose a further reactor space 101. The inner reactor space 38 and the further reactor space 101 may be arranged to accommodate, and optionally secure, a majority of, preferably all, parts of the membrane bioreactor 2 other than the vessels 4, 6 and the support frame 103. The membrane filter device 48 may be placed, with its longitudinal axis vertically positioned, in the inner reactor space 38 between the opposed vessel walls 14, 26. Other parts, preferably all other parts, may be positioned and secured in the inner reactor space 38 and/or in the further reactor space 101 inside the support frame 103.

FIGS. 4B, 5B, 6B, and 7 illustrate embodiments of membrane bioreactor 2 that comprise at least two oppositely positioned bioreaction vessels 4, 6, In use, these vessels respectively house an aerobic zone and an anoxic zone. The vessels 4, 6 may be spherically shaped. Opposite walls 14, 26 of the vessels 4, 6 may be shaped to economically enclose the membrane filter device 48, and optionally also annexed or projected parts (or, in other words, respectively included or provided parts). In this way, a volume of the vessels 4, 6 may be optimized while protection may be provided to parts in the inner reactor space 38 between both vessels. Parts enclosed between both vessels may e.g. be: one or more gas pumps, in particular air pumps (such as, for example, a gas pump of the oxygen supply system 49 and/or a gas pump of the filter device gas supply system 72 illustrated in FIG. 1A); the backwash fluid container 79 that may be part of a permeate back wash system; a mother board and/or interface of the control device 41 for controlling connected process equipment; mounting facilities for various parts; and/or the sewage supply duct 44 (e.g. a sewage supply line) connected to an upper part, e.g. the top, of the second vessel 6. The support frame 103 may be prepared to enclose and/or secure other parts of the membrane bioreactor, such as, for example: a lower end of the membrane filter device 48 and/or fluid flow networks that may be part of the fluid distribution system 40. The support frame 103 may be arranged for attachment to a foundation in situ, such as a soil surface.

In some embodiments, the membrane bioreactor 2 may include vessel fastening means 120, provided on opposite parts of the walls 14, 26 of the vessels 4, 6 (an example of the vessel fastening means 120 is also illustrated in FIG. 2). The vessel fastening means 120 may be arranged for mounting the vessels 4, 6 relative to each other. In some embodiments, the fastening means may be part of the vessel connection structure go. Alternatively, the vessel fastening means 120 may be arranged to connect a vessel connection duct such as a tube at, or near, the lower ends of the vessels 4, 6. The membrane bioreactor may further include further fastening means for realising a mechanical connection to the membrane filter device 48, and/or other annexed or projected parts such as gas pumps such as air pumps, a computer board of the control device, and/or a backwash system (or, in other words, a backwash unit).

The backwash system may include the backwash fluid container 79, and preferably also the filter device gas supply system 72. Optionally, peripheral fastening means may be provided at a periphery of the vessels. Preferably, a wide enough opening 38 may be left between the opposite walls of the vessels 4, 6, in particular between its spherical edges, to enable horizontal movement of parts in and out of the inner reactor space 38. Shutters (not illustrated) may be provided to lock up the inner reactor space 38 by providing a cover that may be connected to to spherical edges of the first and second bioreaction vessel 4, 6. Such spherical edges may for example be formed by the first further vessel wall part 24 and/or the second further vessel wall part 27, as illustrated in FIG. 1A.

The membrane bioreactor 2 may be used after fixing the membrane bioreactor on a proper foundation in situ, such as a foundation formed by paved soil or another soil surface. Use of the membrane bioreactor 2 may include connecting the membrane bioreactor to an energy source. Use of the membrane bioreactor 2 may further include supplying sewage, preferably to the sewage container and/or to the pump for pumping sewage. In some embodiments, a configuration of the membrane bioreactor 2, e.g. an integration of parts of the membrane bioreactor, may enable variations in size and composition of the membrane bioreactor. In this way, an implementation of additional water treatment systems and/or particular means of transport and/or transport conditions may be anticipated. Such means of transport may include, for example, containers or pickup trucks. Such transport conditions may include, for example, relatively poor road conditions and/or local conditions.

The membrane bioreactor 2 may have a membrane filter device 48. In some embodiments, the membrane bioreactor includes other parts that are annexed to, and/or are projected in, the membrane filter device. The membrane filter device may have a longitudinal shape, preferably in a submerged state (i.e., with substantial amounts of sewage being present in the membrane filter device 48). A longitudinal axis of the membrane filter device may be projected vertically (or, in other words, may be provided vertically) between the first vessel wall 14 and the second vessel wall 26. In some embodiments, the membrane filter device 48 may be provided with, preferably may be fixed to, a manifold (illustrated with reference sign 95 in FIGS. 1A, 4B, 5B, and 6B) at a top end of the membrane filter device. The manifold may form the further vessel connection duct 54 and may distribute sewage flowing out of the membrane filter device. By means of the manifold 95, the filter sewage zone outlet may be in fluid communication with the first internal vessel space 5 and the second internal vessel space 7. Thus, the membrane filter device 48 may, at its top end, be connected to the vessels by means of an outflow manifold 95 fixed on the top end of the membrane filter device 48.

In some embodiments, the fluid distribution system, in particular the manifold 95, is equipped with a computer controlled dosing valve system. A computer for controlling the valve system may be included by the control device 41. FIG. 1A schematically shows such a valve system, with reference sign 97. The valve system 97 may be arranged for dividing (or, in other words, distributing) outflow of fluid, e.g. air and/or liquid such as a mix of air and liquid, between the first and second bioreaction vessel 4, 6. The control device 41 may be arranged for the controlling of the dosing valve system 97. The valve system is not required in all embodiments, and may be absent. Additionally, or alternatively, the control device may be arranged for controlling a backwash unit that comprises the backwash fluid container 79, may be arranged for controlling the pump for pumping sewage, may be arranged for controlling the waste outlet valve 85 for the draining of solid matter, such as sludge, to the waste collection container 81 and/or to the sewage container 42 (e.g., to a septic tank), and/or may be arranged for controlling the supply of oxygen to the first internal vessel space 5 and/or the supply of gas to the membrane filter device 48 by means of the filter device gas supply system.

In some embodiments, the membrane filter device may, at its lower end, extend towards, and optionally into, a subframe (or, in other words, a support frame) of the membrane bioreactor. The fluid distribution system may include a further manifold 99 (indicated in FIGS. 1A, 4B, 5B, and 6B) at its lower end. The further manifold may be connected to a further valve system. The further valve system may include the waste outlet valve 85 and the filter supply valve 93. Thus, the further manifold (or, in other words, the inflow manifold) may be connected to the membrane filter device 48 at the down end of the membrane filter device. The further manifold may extend into the support frame 103, i.e. into the further reactor space 101 enclosed by the support frame 103.

The further valve system may be computer controlled. The control device may be arranged for controlling the further valve system. The control device may further be arranged for controlling the backwash unit. It may thus be clear that, in some embodiments, the control device may be arranged for controlling the fluid distribution system, in particular parts thereof such as the waste outlet valve 85, the filter supply valve 93, the pump for pumping sewage, the oxygen supply system, the filter device gas supply system, the valve system, the further valve system, and/or the backwash fluid container that may be included by the backwash unit. Thus, the control device may for example be arranged for controlling the fluid distribution system for controlling flow of drained sludge back to the septic tank 42. The septic tank may be positioned in a zone behind the grinder pump and/or below a discharge fluid flow network (e.g. comprising the waste collection container 81 illustrated in FIG. 1A) through which the solid matter can flow to the septic tank.

In some embodiments, there may be provided a method to backwash a membrane filter for producing permeate, by means of gas pressure, such as air pressure. Preferably, in a filtering mode of the membrane bioreactor 2 wherein the second type of circulating flow may be applied, the outflow of permeate is discharged via a syphon type buffer tank (or, in other words, a water output container that is part of, or forms, a syphon). In some embodiments, an outflow opening in the buffer tank is, in use, determined at a height level that causes accumulation of permeate below that level. In some embodiments, the buffer tank is to be connected to a pressurised gas supply, in particular a pressurised air supply, that is blocked during the filtering of sewage. Preferably, the control device is arranged for automatically unblocking the gas supply in order to block outflow of filtered water. In some embodiments, a method is provided to enable variation in the quantity of accumulated permeate in the buffer tank, by providing outflow openings at different levels, e.g. different height levels. In some embodiments, one or more of these openings are kept closed, e.g. in upgoing sequence, when filtering sewage. During draining of solid matter by means of a backwash, all openings are preferably kept closed.

In some embodiments, the membrane filter device includes membrane straws. Such a straw may form a membrane tube 58 illustrated with reference to FIG. 1B. The membrane straws may have a diameter of at least four millimetre and/or at most five millimetre. In this way, in some embodiments, an optimal flow by means of gas lift may be achieved. Such gas lift may also be referred to as air lift, even if a gas other than air is used. Pre-treatment of sewage may be obsolete and the use of the membrane filter device may be more sustainable. The air lift may be generated by a gas pump, e.g. an air pump. Air lift may go at the expense of the permeate yield capacity. However, air lift may also prevent tight deposition of solid matter, such as particles, on said membrane straws. In some embodiments, said particles on said straws may be drained under atmospheric pressure by a, preferably computer controlled, frequent air pressed backwashing by permeate or permeated mixed with a disinfecting liquid. Using a disinfecting liquid makes the backwash more effective and may allow fluid pumps that are less energy consuming and are more sustainable, since they may only transport clean air.

In some embodiments, a method is provided wherein two gas pumps, or air pumps, are used. One gas pump, or air pump, may be connected to a network for supplying gas, or air, to the membrane filter device 48 and/or to the second internal vessel space 7. Another gas pump, or air pump, may be connected to a fluid flow network for supplying gas, in particular air, to the first internal vessel space 5 and/or to a fluid flow network for supplying gas, in particular air, to the second internal vessel space 7. Supply of gas, e.g. air, to the first internal vessel space 5 may aerate and mix the liquid in the aerobic zone. Supply of gas, e.g. air, to the second internal vessel space 7 may toss about sludge in the anaerobe or anoxic zone. The control device 41 preferably is arranged for connecting the pumps simultaneously to both fluid flow networks or to one of the fluid flow networks, e.g. alternatingly connecting one of the networks to one of the pumps. In the latter way, an capacity of the pumps may be used more effectively so that use of the pumps may be prolonged. This may be useful either in the context of planned processing or in the context of failure. Preferably, in case of failure of the membrane bioreactor 2, e.g. in case of failure of one of the pumps, the control device 41 preferably is arranged for automatically emitting a warning, e.g. automatically sending a warning online, i.e. via the internet.

In some embodiments, the control device is arranged for controlling, at least, the configuration of the support frame, the position of the vessels, flow of sewage through the membrane filter device, flow through the manifold 95 (or, in other words, the outflow manifold 95), which optionally includes a valve system arranged for regulating inlet and outlet of sewage and/or gas, to and/or from the vessels 4, 6 of the membrane filter device 48. Additionally, or alternatively, the control device 41 may be arranged for controlling, at least, flow of sewage to and/or from the first vessel 4 and the second vessel 6, draining of the membrane of the membrane filter device 48, flow of sewage to and/or from the membrane filter device 48, flow of gas by means of the air pumps, and/or the backwash system. The membrane device may be provided with plug and play connections to the control device 41, enabling easy and quick assembly and disassembly. The control device 41 may include various electrical networks, a computer control board and/or interface, a network of electric cables, and/or one or more computer controlled regulators.

In order to arrange the fluid distribution for the functions described herein, the fluid distribution system may be provided with parts of water treatment systems that are known as such. Examples of such parts are ducts such as tubes, valves, sealings, etc. In some embodiments, there are provided methods to contribute to the temperature control of the process characterized in that a heat and cold reflecting shield is projected at least around the vessels 4, 6. The shield may be provided at a distance from the first and second vessel 4, 6. Preferably, a possibility for an effective heat flow is provided by having a cavity formed by the shield that is opened at the top end and down end to enable the formation of vertical air flow through the cavity. Preferably, the shield extends into a pit in the ground consequently covering the support frame. Preferably, a separate air inlet is provided in the pit, enabling cold air to be drawn from the pit. The method moreover includes the possibility of filling the cavity with isolation material, for regulating a temperature of the sewage in the vessels 4, 6. The method moreover may include means for climate control by providing heaters and thermostats needed for keeping the temperature within the membrane bioreactor between 16 and 37 degrees. In some embodiments, the means of climate control may be arranged for providing a temperature of the sewage in the first internal vessel space and/or in the second internal vessel space, of at least 16 degrees Celsius and/or at most 39 degrees Celsius.

In some embodiments, the membrane bioreactor includes provisions to connect the membrane bioreactor to a sustainable energy source, or sustainable energy sources. Example of such sustainable energy source are solar energy, wind energy, and/or geothermal energy. In some embodiments, sustainable energy may be combined with energy accumulators, heaters, and/or or heat pumps for the purpose of controlling the temperature in the membrane bioreactor, e.g. within a range of 16 to 37 degrees. In some embodiments, the provisions are arranged for integrating one or more of these sustainable energy generating sources and/or accumulation means in the configuration of the membrane bioreactor. Thus, in some embodiments, the membrane bioreaction is configured to be completely autonomously operational. Such a membrane bioreactor is in particular suitable for remote territories.

In some embodiments of a membrane bioreactor that is configured according to the invention, the vessels (i.e., the first vessel and the second vessel) are arranged to completely enclose the membrane filter device, in particular the membrane filter device and other annexed parts. Preferably, the inner reactor space generally provides a horizontal space that enables movement, e.g. upwards movement out of the inner reactor space and/or downwards movement into the inner reactor space, of the membrane filter device and optionally other annexed parts. Thus, preferably, the inner reactor space may provide a large enough horizontal opening at its top to enable vertical movement of the membrane filter device and optionally of other parts in and out of the inner reactor space. In some embodiments, the vessels may be arranged to, at least partially, enclose the membrane filter device and optionally other parts. Thus, the vessel may leave a wide enough open space between the walls of those vessels to enable horizontal movement of those parts in and out. Preferably, lockable means are provided to cover the inner reactor space, such as a shield, in particular a housing, of the membrane bioreactor.

In some embodiments, the membrane bioreactor is arranged for other types of water treatment, such as ultra violet treatment, coagulation treatment, active coal treatment or the accumulation of permeate (or, in other words, effluent) for accumulation of permeate and cleansing fluid. Such other types of water treatment are known as such, for example from U.S. Pat. No. 7,820,047. Parts needed for such other types of water treatment may be accommodated in the membrane bioreactor, preferably, at least partly, in the inner reactor space 38.

In a first method, which may be applied independently from, or in combination with, any embodiment, example, aspect, variation and/or preferred or optional feature described herein, there is provided a compactly assembled and ready to operate mobile membrane bioreactor that forms a unit that is transportable, preferably by light means, the membrane bioreactor preferably being provided instead of a large scale high quality permeate producing membrane bioreactor. Preferably, the first method includes projecting a membrane filter device of the membrane bioreactor with the longitudinal axis of the membrane filter device being vertical and the membrane filter device preferably being unsubmerged, and optionally also includes projecting annexed and/or other projected parts that are needed for processing of sewage by means of the membrane bioreactor, in between vertical walls of two mutually oppositely projected bioreaction vessels, the membrane filter device being supported by a support frame of the membrane bioreactor, wherein the opposite walls are shaped and projected at a mutual distance so that they, preferably, in terms of space, economically enclose said membrane filter device and the annexed and/or projected parts, wherein the membrane filter device is equipped to be connected to the vessels by means of an outflow manifold that is fixed on the membrane filter device. Preferably, the first method includes dividing an outflow of air and mixed liquid to the vessels by means of an outflow manifold that is provided with a computer controlled dosing valve system, wherein, preferably, the assembly of the membrane filter device and optionally the annexed and/or projected parts does not extend above the vessels and, at a down end, preferably extends into the support frame that supports the vessels, the method including connecting the vessels to a projected manifold that optionally comprises a computer controlled valve system that is to be connected, or is connected, to a projected mixed fluid supply network, an air supply network, and/or a draining network, wherein the method preferably includes attaching the support frame to a foundation in situ while keeping a sufficient distance between the foundation and the assembly of the manifold and connected networks to allow proper assembly and disassembly of the membrane bioreactor.

A second method according to the first method, further includes reducing a risk of blockage of the membrane filter device by using, in the membrane filter device, straws with a diameter in a range from four to five millimetre.

A third method according to the first and second method, further includes reducing the risk of blockage of the membrane filter device by providing a backwash and flow meter system and adjusting, by means of the backwash and flow meter system, the frequency of the process of draining and backwashing by permeate when detecting a deviation from a defined, and preferably ideal, flow rate in the membrane bioreactor.

There is also provided the back wash system of the third method, wherein the system is arranged, in a filtering mode, for outflow of the permeate from the membrane filter being discharged via a syphon type of buffer tank that is connected to a permeate outflow opening at a determined liquid level, wherein the buffer tank, above a liquid level in the buffer tank, is connected to a supply of pressurized air, said supply being closed in the filtering mode, wherein, in a back washing mode, the permeate outflow opening in the tank is closed and the air inflow opening is opened. Thus, a fourth method according to the third method, includes providing, by means of the back wash system, in a filtering mode, outflow of the permeate from the membrane filter and discharging the permeate via a syphon type of buffer tank that is connected to a permeate outflow opening at a determined liquid level, wherein the buffer tank, above a liquid level in the buffer tank, is connected to a supply of pressurized air, said supply being closed in the filtering mode, wherein, in a back washing mode, the permeate outflow opening in the tank is closed and the air inflow opening is opened.

A fifth method according to the third and fourth method, includes adjusting a level of accumulated permeate by providing the buffer tank with a series of vertically sequentially projected outflow openings of which one or more lower ones remain closed in the filtering mode and all are closed in the backwash mode.

A sixth method according to the fourth and fifth method, includes projecting a cleaning agent holding tank in an upper position, connected so to the water output container via a one way valve, wherein the opening of the valve is controlled by means of a computer, wherein, directly before switching to the backwash mode, said valve is temporarily opened to let a variably determinable amount of cleaning agent (or, in other words, disinfection fluid) flow in the water output container. The water output container may optionally form a buffer tank.

A seventh method according to one of the first to sixth method, includes protecting the membrane bioreactor by means of a shield that is projected to surround at least the periphery of the vessels. Preferably, the shield is suitable for reflecting heat and cold. Preferably the shield is provided at such a distance from the peripheral wall parts of the vessels as to cause a convection stream through the cavity enclosed by the shield.

An eight method according to the sixth and seventh method, includes filling the cavity with isolation material.

A ninth method according to one of the first to eighth method, includes securing and intermittently optimizing the supply of pressurized gas, in particular air, to separate airflow networks of the membrane bioreactor. Preferably, two computer-controlled air pumps are provided, equipped to supply pressurized gas, in particular air. Preferably, simultaneously to two airflow networks may be provided. One air pump may be provided on its own to one of the networks. One of the air pumps may on its own be provided to the two networks.

There is also provided a membrane bioreactor that is configured and constructed to be applied in one of the first to ninth method. In an embodiment, the oppositely positioned walls of the vessels are modulated to completely surround the parts projected between those vessels, wherein a large enough horizontal opening is provided at the top end of the membrane bioreactor nit to move the enclosed parts in vertical direction in and out the space of the membrane bioreactor between the vessels. Preferably, the membrane bioreactor is configured according the one of the first to ninth method. Preferably, the two oppositely positioned vessels 4, 6 are spherically shaped at their periphery and the opposite vessel wails are mutually connected by a vessel connection structure (or, in other words, connection means). Preferably, at their lower end the vessels are in open communication connected by means of a tube. The first internal vessel space 5 may be connected at its lower end to the further manifold, e.g. inflow manifold, that is connected to the membrane filter device 48. The inflow manifold may also be connected to one or two gas pumps, in particular air pumps, which may be included by the filter device gas supply system 72 (illustrated in FIG. 1A). The inflow manifold may also be connected to a computer board that may be included by the control device 41, and/or to the back wash system. The membrane bioreactor may be arranged to secure the position of such parts and leave a wide enough opening between adjacent spherical edges of the vessels to enable horizontal movement of those parts in and out of the inner reactor space 38 and/or the further reactor space 101. Shutters and fasteners may be provided to temporarily lock up the opening. The vessels 4, 6 may be supported by a subframe (or, in other words, a support frame) that is configured to house containers for accumulation of permeate, sewer dry sludge. Such containers may be arranged for various sorts of water treatment configurations like ultra violet treatment, coagulation treatment and/or active coal treatment.

In an embodiment, the vessels 4, 6 are arranged to partially surround parts positioned in between the walls 14, 26 of the vessels 4, 6, leaving a wide enough inner reactor space 38 to manually operate a computer interface of the control means and to enable horizontal moving of those parts in and out of the membrane bioreactor.

In an embodiment, the membrane bioreactor is provided with lockable covering means that are arranged to close openings of the membrane bioreactor. Thus, the membrane bioreactor may be provided with a bioreactor housing. The lockable covering may enable protection of the membrane bioreactor, for example against sand, wind, rain etc.

There is also provided a second membrane bioreactor that is configured and constructed according the membrane bioreactor of one of the first to ninth method, wherein at least the support frame, the vessels, the membrane filter device provided with the manifold and the further manifold, optionally provided with valve systems for regulating flow of air and liquid to and from the vessels 4, 6, the computer control board and interface, the cable network connecting that control board to the process regulators, and the backwash system, may be provided with pre-assembled fittings and counter fittings.

There is also provided a membrane bioreactor that is configured and constructed according to the membrane bioreactor of the first method, wherein fittings and counter fittings are positioned so that alternative parts provided with identical fittings can be put in place and secured in exchange for original parts.

A tenth method, according to the first and second method, includes projection of a shield surrounding parts of the membrane bioreactor, prepared to reflect heat and cold and being projected so that, in conjunction with the peripheral wall parts, overall even cavities are formed that are suitable for causing a convective flow through the cavity.

In an embodiment, the shield is projected to extend into a pit, thereby covering the support frame so that the pit and the cavity form one closed volume provided with an opening at the top and an air inlet in the pit in communication with the atmosphere.

In one of the first to fourth methods, the membrane bioreactor is configured so that the vessels are shaped so that the vessel walls form inner surfaces that are smoothly shaped, so that dead ends are avoided and so that horizontal planes are made to slope.

There is also provided a membrane bioreactor that is constructed and can be operated according the a method according to one of the first to ninth method in combination with a membrane bioreactor as disclosed herein. Preferably, the vessels 4, 6 and their support frame parts are made of one piece, so that the total volume of vessel and subframe parts is horizontally divided into two separated volumes by means of intersections. Preferably, the vessels and the support frame are each made of one piece.

The embodiments described herein illustrate various features. Features disclosed in relation to one or more of the embodiments described herein, may be applied in other embodiments as well. For example, the one or more handles for moving the membrane bioreactor described with reference to the further embodiment of the membrane bioreactor, form optional features that may be applied in other embodiments as well. Similarly, features like the froth removal elements, the first circulating flow, the second circulating flow, the alternating between the first and second circulating flow, form optional features that may be applied in other embodiments as well. The invention is not limited to the embodiments described with reference to the figures, and may be embodied in other ways as well. It may be appreciated that the first and second peripheral vessel wall parts may both be shaped as a part of a sphere. Thus, the first vessel wall may be partly spherical and the second vessel wall may be partly spherical. The first peripheral vessel wall part and the second peripheral vessel wall part may extend substantially along the contour of one and the same sphere.

The invention is not limited to an aspect, embodiment, feature, variation, or example of the present disclosure. All kinematic inversions are considered to be inherently disclosed and to be within the scope of the present disclosure. The use of expressions like “preferably”, “more preferably”, “typically”, “in particular”, “particularly”, “in a variation”, “e.g.”, “for example”, “such as”, “may”, “can”, “could”, “embodiment”, “aspect” etc. is not intended to limit the invention. Use herein of terms like “a”, “an”, “the” etc. does not exclude a plurality. The term “step” may refer to any part of a method. The term “at least part of” a feature may imply both a part of that feature and the feature as a whole. Similarly, terms like “at least partially” or “at least partly” may imply the option “partially” or “partly”, and the option “completely”. Mechanical connections, mechanically connecting etc. as disclosed herein preferably refers to rigid mechanical connections, rigidly mechanically connecting etc. Mechanical connections may be fixed, or may be arranged for disconnection so that mechanically connected parts can be disassembled. Similarly, mechanically connecting may imply a fixed mechanical connection or a mechanical connection that is arranged for disconnection so that mechanically connected parts can be disassembled.

Length may e.g. be expressed in metre, centimetre, or millimetre. Temperature may be expressed in degrees Celsius. The beginning of a decimal fraction may be marked by a period. The term “similar” may refer to a limited variation wherein the larger variable differs from the smaller variable by at most 10% of the larger variable. The term “duct” as used herein may be interpreted broadly, and may refer to a (flexible or rigid) tube, pipe, channel, conduit, or to other, similar, elements of a fluid flow network. The term solid matter as used herein may be interpreted broadly, as may include various kinds of matter such as organic matter, inorganic matter, microorganisms, floating particle, dispersed particles, etc. The terms “project”, “projecting”, “projection” etc. used herein are to be interpreted as meaning respectively “provide”, “providing”, provision” etc. The terms “annex”, “annexed” etc. used herein are to be interpreted as meaning respectively “include”, “included” etc. The use of terms like “first”, “second”, “third” etc. when indicating a feature or step does not imply a order or preference, but is merely in order to distinguish between features or steps.

1. Membrane bioreactor that is arranged for treating of sewage, wherein the membrane bioreactor is arranged to be transportable and includes a first bioreaction vessel and a second bioreaction vessel, wherein the first bioreaction vessel includes a first vessel wall for enclosing a first internal vessel space, and wherein the second bioreaction vessel includes a second vessel wall for enclosing a second internal vessel space, wherein the first vessel wall includes a first peripheral vessel wall part and includes a first inner vessel wall part that is mechanically connected to the first peripheral vessel wall part, and wherein the second vessel wall includes a second peripheral vessel wall part and includes a second inner vessel wall part that is mechanically connected to the second peripheral vessel wall part, wherein the first inner vessel wall part is positioned, at least partly, opposite to the second inner vessel wall part, and wherein the first vessel wall and the second vessel wall are mechanically connected to each other by means of a vessel connection structure, wherein the membrane bioreactor is arranged for providing, for the treating of sewage, in the first internal vessel space an aerobic zone and in the second internal vessel space an anoxic zone, wherein the membrane bioreactor includes a fluid distribution system that is arranged for flow of sewage from the aerobic zone to the anoxic zone and/or from the anoxic zone to the aerobic zone, wherein the first peripheral vessel wall part has a convex shape and the second peripheral vessel wall part has a convex shape, and the vessel connection structure is arranged to position the convex first peripheral vessel wall part and the convex second peripheral vessel wall part relative to each other during the treating of sewage.

2. Membrane bioreactor according to claim 1, wherein the first peripheral vessel wall part, at least partly, is shaped substantially as a part of a sphere and wherein the second peripheral vessel wall part, at least partly, is shaped substantially as a part of a sphere.

3. Membrane bioreactor according to claim 1, wherein the first peripheral vessel wall part and the second peripheral vessel wall part have a similar shape.

4. (canceled)

5. Membrane bioreactor according to claim 1, wherein the first inner vessel wall part is, at least partly, spaced apart from the second inner vessel wall part so that the first inner vessel wall part and the second inner vessel wall part define an inner reactor space that is in between the first bioreaction vessel and the second bioreaction vessel.

6. Membrane bioreactor according to claim 5, wherein the first inner vessel wall part and the second inner vessel wall part are mechanically connected to each other by means of the vessel connection structure, wherein the vessel connection structure is provided, at least partly, in the inner reactor space that is in between the first bioreaction vessel and the second bioreaction vessel, and/or wherein the fluid distribution system is provided, at least partly, in the inner reactor space that is in between the first bioreaction vessel and the second bioreaction vessel.

7. Membrane bioreactor according to claim 5, wherein the first inner vessel wall part and the second inner vessel wall part are substantially flat, and/or wherein the inner reactor space is substantially disc-shaped.

8. Membrane bioreactor according to claim 1, wherein the vessel connection structure includes a first vessel connection structure part that is mechanically connected to the first vessel wall and includes a second vessel connection structure part that is mechanically connected to the second vessel wall, wherein the first vessel connection structure part and the second vessel connection structure part are arranged to be mechanically coupled to each other.

9. Membrane bioreactor according to claim 1, wherein the vessel connection structure includes a plurality, in particular at least three or at least four, vessel connection elements that are arranged to position the first peripheral vessel wall part and the second peripheral vessel wall part relative to each other, wherein each vessel connection element of the plurality of vessel connection elements forms a mechanical connection from the first vessel wall to the second vessel wall that is separate from the other vessel connection elements of the plurality of vessel connection elements.

10. Membrane bioreactor according to claim 8, wherein the vessel connection structure includes a plurality, in particular at least three or at least four, vessel connection elements that are arranged to position the first peripheral vessel wall part and the second peripheral vessel wall part relative to each other, wherein each vessel connection element of the plurality of vessel connection elements forms a mechanical connection from the first vessel wall to the second vessel wall that is separate from the other vessel connection elements of the plurality of vessel connection elements and wherein the first vessel connection structure part and the second vessel connection structure part form the plurality of vessel connection elements, wherein the first vessel connection structure part includes a plurality of first vessel coupling elements and the second vessel connection structure part includes a plurality of second vessel coupling elements, wherein pairs of one of the first vessel coupling elements coupled to one of the second vessel coupling elements, form at least parts of the vessel connection elements.

11. (canceled)

12. Membrane bioreactor according to claim 1, wherein the fluid distribution system is arranged for providing a first circulating flow of sewage, from the first internal vessel space to the second internal vessel space and from the second internal vessel space to the first internal vessel space.

13. Membrane bioreactor according to claim 12, wherein the fluid distribution system includes a vessel connection duct that extends from the first vessel wall to the second vessel wall and includes a further vessel connection duct that extends from the first vessel wall to the second vessel wall, the fluid distribution system being arranged for flow of sewage from the first internal vessel space to the second internal vessel space via the further vessel connection duct and from the second internal vessel space to the first internal vessel space via the vessel connection duct, wherein the membrane bioreactor is arranged for providing the first circulating flow of sewage from the aerobic zone to the anoxic zone via the further vessel connection duct and from the anoxic zone to the aerobic zone via the vessel connection duct.

14. Membrane bioreactor according to claim 13, wherein, in use, the further vessel connection duct is positioned higher than the vessel connection duct.

15. Membrane bioreactor according to claim 12, wherein the fluid distribution system includes an oxygen supply system that is arranged for providing oxygen to the first internal vessel space, for providing the aerobic zone in the first internal vessel space and wherein the fluid distribution system is arranged for driving said first circulating flow by at least the oxygen supply system.

16. (canceled)

17. Membrane bioreactor according to claim 1, wherein the fluid distribution system includes a membrane filter device that includes a membrane for filtering sewage to obtain filtered water, wherein the membrane filter device has a filter sewage zone and has a filtered water zone that is separated from the filter sewage zone by means of the membrane, wherein the filter sewage zone has a filter sewage zone inlet and a filter sewage zone outlet and the fluid distribution system is arranged for flow of sewage, from the filter sewage zone outlet, to the aerobic zone and/or to the anoxic zone.

18. Membrane bioreactor according to claim 5, wherein the fluid distribution system includes a membrane filter device that includes a membrane for filtering sewage to obtain filtered water, wherein the membrane filter device has a filter sewage zone and has a filtered water zone that is separated from the filter sewage zone by means of the membrane, wherein the filter sewage zone has a filter sewage zone inlet and a filter sewage zone outlet and the fluid distribution system is arranged for flow of sewage, from the filter sewage zone outlet, to the aerobic zone and/or to the anoxic zone and wherein the membrane filter device at least partly extends in the inner reactor space that is in between the first bioreaction vessel and the second bioreaction vessel.

19. Membrane bioreactor according to claim 18, wherein the first vessel wall has a lower first vessel wall part and an upper first vessel wall part, and the second vessel wall has a lower second vessel wall part and an upper second vessel wall part, wherein the membrane filter device has a longitudinal shape and extends at least partly in the inner reactor space from the lower first and lower second vessel wall parts to the upper first and upper second vessel wall parts.

20. Membrane bioreactor according to claim 17, wherein the fluid distribution system is arranged for providing a second circulating flow of sewage, from the first internal vessel space and/or from the second internal vessel space, to the filter sewage zone inlet, and from the filter sewage zone outlet to the first internal vessel space and/or to the second internal vessel space.

21. Membrane bioreactor according to claim 20, wherein the fluid distribution system includes a filter device gas supply system for providing upward flow of sewage from the filter sewage zone inlet to the filter sewage zone outlet, wherein the fluid distribution system is arranged for flow of sewage from the first internal vessel space and/or from the second internal vessel space, to the filter sewage zone inlet, and for flow of sewage from the filter sewage zone outlet to the first internal vessel space and/or to the second internal vessel space, wherein the membrane bioreactor is arranged for providing the second circulating flow of sewage from the filter sewage zone outlet to the aerobic zone and/or to the anoxic zone, and from the aerobic and/or anoxic zone to the filter sewage zone inlet, said flow being driven at least by the filter device gas supply system.

22. Membrane bioreactor according to claim 12, wherein the fluid distribution system is arranged for providing a second circulating flow of sewage, from the first internal vessel space and/or from the second internal vessel space, to the filter sewage zone inlet, and from the filter sewage zone outlet to the first internal vessel space and/or to the second internal vessel space and wherein the fluid distribution system is arranged for alternating between providing the first circulating flow and providing the second circulating flow.

23. Membrane bioreactor according to claim 17, wherein the filtered water zone has a filtered water zone outlet and the fluid distribution system includes a water output container for collecting the filtered water, wherein the fluid distribution system is arranged for flow of filtered water from the filtered water zone outlet to the water output container.

24. Membrane bioreactor according to claim 17, wherein the filtered water zone has a filtered water zone inlet and the fluid distribution system includes a backwash fluid container that is arranged to contain a backwash fluid, wherein the fluid distribution system is arranged for flow of the backwash fluid to the filtered water zone inlet, wherein the fluid distribution system is arranged for pressurising the backwash fluid contained in the backwash fluid container relative to a fluid in the filter sewage zone, so that the backwash fluid can be pressurised to flow through the membrane of the membrane filter from the filter outlet zone to the filter inlet zone.

25. Membrane bioreactor according to claim 23, wherein the backwash fluid container is formed by the water output container, and/or wherein the filtered water zone inlet is formed by a part of the fluid distribution system that forms the filtered water zone outlet during flow of filtered water from the filtered water zone to the water output container.

26. Membrane bioreactor according to claim 17, wherein the fluid distribution system includes a waste collection container for collecting solid matter contained in the sewage, wherein the filter sewage zone has a further sewage zone outlet for flow of sewage containing solid matter to the waste collection container, wherein the fluid distribution system is arranged for flow of sewage containing solid matter from the further sewage zone outlet to the waste collection container.

27. Membrane bioreactor according to claim 17, wherein the fluid distribution system includes a sewage container for collecting sewage or is provided in combination with the sewage container for collecting sewage, wherein the fluid distribution system includes a pump for pumping sewage from the sewage container to the first internal vessel space and/or the second internal vessel space, wherein the pump is a cutting pump arranged for reducing a size of solid matter contained in the sewage and wherein the filter sewage zone has a further sewage zone outlet for flow of sewage containing solid matter to the waste collection container, wherein the fluid distribution system is arranged for flow of sewage containing solid matter from the further sewage zone outlet to the sewage container.

28. Membrane bioreactor according to claim 1, wherein the fluid distribution system includes, in the second internal vessel space, a froth removal element that has an inner element space and that, in use, extends above a water level in the second vessel space to a height that enable froth floating on the water level to flow into the internal element space.

29. Method of operating a membrane bioreactor that is arranged to be transportable and includes a first bioreaction vessel and a second bioreaction vessel, wherein the first bioreaction vessel includes a first vessel wall and the second bioreaction vessel includes a second vessel wall, wherein the method includes:
enclosing a first internal vessel space by means of the first vessel wall, and enclosing a second internal vessel space by means of the second vessel wall;
providing a first peripheral vessel wall part of the first vessel wall mechanically connected to a first inner vessel wall part of the first vessel wall, and providing a second peripheral vessel wall part of the second vessel wall mechanically connected to a second inner vessel wall part of the second vessel wall;
providing the first inner vessel wall part positioned opposite to the second inner vessel wall part, and providing the first vessel wall and the second vessel wall, by means of a vessel connection structure of the membrane bioreactor, mechanically connected to each other;
treating the sewage by providing, by means of the membrane bioreactor, in the first internal vessel space an aerobic zone and in the second internal vessel space an anoxic zone;
treating the sewage by providing flow of sewage, by means of a fluid distribution system of the membrane bioreactor, from the aerobic zone to the anoxic zone and/or from the anoxic zone to the aerobic zone; and
providing the first peripheral vessel wall part and the second peripheral vessel wall part positioned relative to each other by means of the vessel connection structure during the treating of sewage, wherein the first peripheral vessel wall part has a convex shape and the second peripheral vessel wall part has a convex shape.

30. Method according to claim 29, including:
providing the first inner vessel wall part, at least partly, spaced apart from the second inner vessel wall part so that the first inner vessel wall part and the second inner vessel wall part define an inner reactor space that is in between the first bioreaction vessel and the second bioreaction vessel.

31. Method according to claim 30, including:
providing the vessel connection structure, at least partly, in the inner reactor space that is in between the first bioreaction vessel and the second bioreaction vessel and/or providing the fluid distribution system provided, at least partly, in the inner reactor space that is in between the first bioreaction vessel and the second bioreaction vessel.

32. Method according to claim 29, including:
treating the sewage by providing, by means of the fluid distribution system, a first circulating flow of sewage, from the first internal vessel space to the second internal vessel space and from the second internal vessel space to the first internal vessel space.

33. Method according to claim 32, wherein the fluid distribution system includes a vessel connection duct that extends from the first vessel wall to the second vessel wall and includes a further vessel connection duct that extends from the first vessel wall to the second vessel wall, the method including:
treating the sewage by providing, by means of the membrane bioreactor, the first circulating flow of sewage from the aerobic zone to the anoxic zone via the further vessel connection duct and from the anoxic zone to the aerobic zone via the vessel connection duct.

34. Method according to claim 29, wherein the fluid distribution system includes a membrane filter device that includes a membrane, wherein the membrane filter device has a filter sewage zone and has a filtered water zone that is separated from the filter sewage zone by means of the membrane, wherein the filter sewage zone has a filter sewage zone inlet and a filter sewage zone outlet, the method including:
filtering, by means of the membrane of the membrane filter device, sewage to obtain filtered water during flow of sewage from the filter sewage zone inlet to the filter sewage zone outlet.

35. Method according to claim 34, including:
providing, by means of the fluid distribution system, a second circulating flow of sewage, from the first internal vessel space and/or from the second internal vessel space, to the filter sewage zone inlet, and from the filter sewage zone outlet to the first internal vessel space and/or to the second internal vessel space.

36. Method according to claim 35, wherein the fluid distribution system includes a filter device gas supply system for providing upward flow of sewage from the filter sewage zone inlet to the filter sewage zone outlet, wherein the fluid distribution system is arranged for flow of sewage from the first internal vessel space and/or from the second internal vessel space, to the filter sewage zone inlet, and for flow of sewage from the filter sewage zone outlet to the first internal vessel space and/or to the second internal vessel space, the method including:
providing, by means of the membrane bioreactor, the second circulating flow of sewage from the filter sewage zone to the aerobic zone and/or to the anoxic zone, and from the aerobic zone and/or from the anoxic zone, to the filter sewage zone, said flow being driven at least by the filter device gas supply system.

37. Method according to claim 29, including transporting the membrane bioreactor, preferably by means of a forklift and/or a pickup truck.

38. (canceled)
